(19) United States
(12) Patent Application Publication
(10) Pub. No.: US 2021/0042089 A1
(43) Pub. Date: Feb. 11, 2021

(54) RE-CONFIGURABLE AND EFFICIENT NEURAL PROCESSING ENGINE POWERED BY TEMPORAL CARRY DIFFERING MULTIPLICATION AND ADDITION LOGIC

(71) Applicant: George Mason University, Fairfax, VA (US)

(72) Inventors: Avesta Sasan, Fairfax, VA (US); Ali Mirzaeian, Fairfax, VA (US)

(21) Appl. No.: 16/944,901

(22) Filed: Jul. 31, 2020

Related U.S. Application Data
(60) Provisional application No. 62/882,812, filed on Aug. 5, 2019.

(51) Int. Cl. G06F 7/575; G06N 3/04; G06F 7/544; G06F 7/72

(52) U.S. Cl. CPC G06F 7/575; G06F 7/72; G06F 7/5443; G06N 3/04

(57) ABSTRACT

A Temporal-Carry-Deferring Multiplier-Accumulator (TCD-MAC) is described. The TCD-MAC can gain significant energy and performance benefit when utilized to process a stream of input data. A specialized Neural engine significantly accelerates the computation of convolution layers in a deep convolutional neural network, while reducing the computational energy. Rather than computing the precise result of a convolution per channel, the Neural engine quickly computes an approximation of its partial sum and a residual value such that if added to the approximate partial sum, generates the accurate output. The TCD-MAC is used to build a reconfigurable, high speed, and low power Neural Processing Engine (TCD-NPE). A scheduler lists the sequence of needed processing events to process an MLP model in the least number of computational rounds in the TCD-NPE. The TCD-NPE significantly outperform similar neural processing solutions that use conventional MACs in terms of both energy consumption and execution time.

### CROSS-REFERENCE TO RELATED APPLICATION

This application is a conversion of Provisional Application Ser. No. 62/882,812 filed Aug. 5, 2019, the disclosure of which is incorporated herein by reference. Applicants claim the benefit of the filing date of the provisional application.

### STATEMENT REGARDING FEDERALLY SPONSORED RESEARCH OR DEVELOPMENT

This invention was made with government support under grant number 1718538 awarded by the National Science Foundation. The government has certain rights in the invention.

### DESCRIPTION

### BACKGROUND OF THE INVENTION

### Field of the Invention

The present invention generally relates to enhancing the performance of Multiplication and Accumulation (MAC) operation when working on an input data stream larger than one and, more particularly, to a MAC engine which uses temporal carry bits in a temporal carry differing multiplication and accumulation (TCD-MAC) logic unit. Further, the TCD-MAC is used as a basic block for the architecture of a NeuralProcessing Engine (TCD-NPE) which is an accelerator for Multi-Layer Perceptron (MLP) applications. We also introduced NESTA as another use case of TCD-NPE for processing Convolutional Neural Networks (CNN).

### Background Description

Deep neural networks (DNNs) has attracted a lot of attention over the past few years, and researchers have made tremendous progress in developing deeper and more accurate models for a wide range of learning-related applications. The concept of Neural Network was introduced in 1943 and excited many researchers in the next two decades to develop models and theories around the subject. However, efficient computation (for training and test) of these complex models needed a computational platform (hardware) that did not exist at the time. In the past decade, however, the availability and rapid development in Graphical Processing Units (GPUs) gave fresh blood to this research area and allowed researchers to develop and deploy very deep, capable, and accurate yet trainable and executable learning models.

On the platform (hardware) side, the GPU solutions have rapidly evolved over the past decade and are considered as a prominent means of training and executing DNN models. Although the GPU has been a real energizer for this research domain, its is not an ideal solution for efficient learning, and it is shown that development and deployment of hardware solutions dedicated to processing the learning models can significantly outperform GPU solutions. This has lead to the development of Tensor Processing Units (TPUs), Field Programmable Gate Array (FPGA) accelerator solutions, and many variants of dedicated Application Specific Integrated Circuit (ASIC) solutions.

Today, there exist many different flavors of ASIC neural processing engines. The common theme between these architectures is the usage of a large number of simple Processing Elements (PEs) to exploit the inherent parallelism in DNN models. Compared to a regular Central Processing Unit (CPU) with a capable Arithmetical Logic Unit (ALU), the PE of these dedicated ASIC solutions is stripped down to a simple Multiplication and Accumulation (MAC) unit. However, many PEs are used to either form a specialized data flow, or tiled into a configurable Network on Chip (NoC) for parallel processing DNNs. The observable trend in the evolution of these solutions is the optimization of data flow to increase the re-use of information read from memory, and to reduce the data movement (in NoC and to/from memory).

Common between previously named ASIC solutions, is designing for data reuse in NoC level but ignoring the possible optimization of the PEs MAC unit. A conventional MAC operates on two input values at a time, computes the multiplication result, adds it to its previously accumulated sum and outputs a new and accumulated sum. When working with streams of input data, this process takes place for every input pair taken from the stream. But in many applications, we are not interested in the correct value of intermediate partial sums, we are only interested in the correct final result.

The MAC is an essential part of most computing systems. Any system that performs data stream processing one way or another uses a MAC engine. The MAC engines are used in a variety of applications including image processing, video processing, neural network processing, etc.

### SUMMARY OF THE INVENTION

The invention is a substantial advancement in the design of MAC units. It introduces the new concept of temporal carry bits, in which rather than propagating the carry bits down into the carry chain, it defers and injects the carry bits to the next round of computation. This solution has its best efficiency when a large number of MAC operations need to be done.

More specifically, the invention is a Temporally-Carry-Deferring MAC (TCD-MAC), and the use the TCD-MAC to build a reconfigurable, high speed, and low power MLP Neural Processing Engine (TCD-NPE), and also a CNN Neural Processing Engine (NESTA). The TCD-MAC can produce an approximate-yet-correctable result for intermediate operations, and can correct the output in the last state of stream operation to generate the correct output. TDC-NPE uses an array of TCD-MACs (used as PEs) supported by a reconfigurable global buffer (memory). The resulting processing engine is characterized by superior performance and lower energy consumption when compared with the state of the art ASIC NPU solutions. To remove the data flow dependency, we used our proposed NPE to process various Fully Connected Multi-Layer Perceptrons (MLP) to simplify and reduce the number of data flow possibilities. This focuses attention on the impact of PE in the efficiency of the resulting accelerator.

According to another aspect of the invention, we present NESTA, a specialized Neural engine that significantly accelerates the computation of convolution layers in a deep convolutional neural network, while reducing the computational energy. NESTA reformats convolutions into, for example, 3×3 kernel windows and uses a hierarchy of Hamming Weight Compressors to process each batch (the kernel windows being variable to suit the needs of the design or designer). Besides, when processing the convolution across multiple channels, NESTA, rather than computing the precise result of a convolution per channel, quickly computes an approximation of its partial sum, and a residual value such that if added to the approximate partial sum, generates the accurate output. Then, instead of immediately adding the residual, it uses (consumes) the residual when processing the next channel in the hamming weight compressors with available capacity. This mechanism shortens the critical path by avoiding the need to propagate carry signals during each round of computation and speeds up the convolution of each channel. In the last stage of computation, when the partial sum of the last channel is computed, NESTA terminates by adding the residual bits to the approximate output to generate a correct result.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing and other objects, aspects and advantages will be better understood from the following detailed description of a preferred embodiment of the invention with reference to the drawings, in which:

FIGS. 1A-1 and 1A-2 are block and flow diagrams of a typical MAC, and FIGS. 1B-1 and 1B-2 are simplified 2-input versions of the TCD-MAC according to the invention;

FIG. 2 is an example of timing diagram illustrating the TCD-MAC shown FIG. 7A, has a cycle time computed by Posing the Partial Carry Propagation Accumulation (PCPA)insidethe skip block;

FIGS. 3A-3C are flow diagrams illustrating how the TCD-MAC, configured to calculate a 1×1 kernel window, while PCPA poses inside the skip block, generates the result of [(5×7)+(4×−2)+(6×3)+(7×−8)+(7'7)=38] at cycle 6;

FIG. 4 is a diagram of a Hamming Weight Adder (WHA) compressor hierarchy versus typical tree-adder for summing nine 16-bit values;

FIGS. 5A-5C are exemplary block diagrams of TDC-MAC, configured to process kernel window 3*3 of 16-bit values while PCPA exist in skip-path, made by capturing the carry signals in a Carry Propagation Adder (CPA) in the first logic level resulting in carry signals that are captured in a Carry Buffer Unit (CBU);

FIG. 6 is a diagram of a Data Reshape Unit (DRU) for a TCD-MAC configured in a kernel-window 1*1 of N-bit values;

FIGS. 7A and 7B are block diagrams showing two different configurations of TCD-MAC by posing different components inside the skip block;

FIG. 7C shows the control flow of TCD-MAC when it uses the setup shown in FIG. 7A, where TCD-MAC supports two modes of operations 1) Carry Differing Mode (CDM) and 2) Carry Propagation Mode (CPM), and based on the initial setup of TCD-MAC either of these modes of operations can be activated;

FIG. 8 are graphs illustrating energy and latency swept for the two designs of TCD-MAC with different skip block, illustrated in FIGS. 7A and 7B;

FIG. 9 is a block diagram illustrating the TCD-NPE, overall architecture;

FIG. 10 is a block diagram of the logic implementation of Quantization (Left) and Relu Activation (Right) for fixed point 16-bit values;

FIGS. 11A-11D are block diagrams illustrating an activity map for a configuration of 6×3 PE-array of TCD-MACs;

FIGS. 12A-12B are block diagrams of an example of a computational tree used to process (5,7) model using an array of TCD-MAC in 6×3 configuration layout;

FIGS. 13A-13C are block diagrams of an example of data arrangement at FM-Mem and W-Mem for (2,64) using TCD-NPE(2,64);

FIGS. 14A-14B are logic diagrams of an example of a Local Distributed Network (LDN) for managing the connection between (6×3)-PE array's NoC and memory;

FIG. 15 is a graph of computational time for two sets of large datasets and small datasets; and

FIGS. 16A-16D are block diagrams of four possible data flows for processing and MLP model.

### DETAILED DESCRIPTION THE INVENTION

Before describing our proposed NPE solution, we first describe the concept of temporal carry and illustrate how this concept can be utilized to build a Temporal-Carry-Deferring Multiplication and Accumulation (TCD-MAC) unit. Then, we describe, how an array of TCD-MACs are used to design a re-configurable and high-speed MLP processing engine, and how the sequence of operations in such NPE is scheduled to compute multiple batches of MLP models.

Suppose two vectors A and B each have N M-bit values, and the goal is to compute their dot product,

$${\sum }_{i = 0}^{N - 1} ( {A}_{i} * {B}_{i} )$$

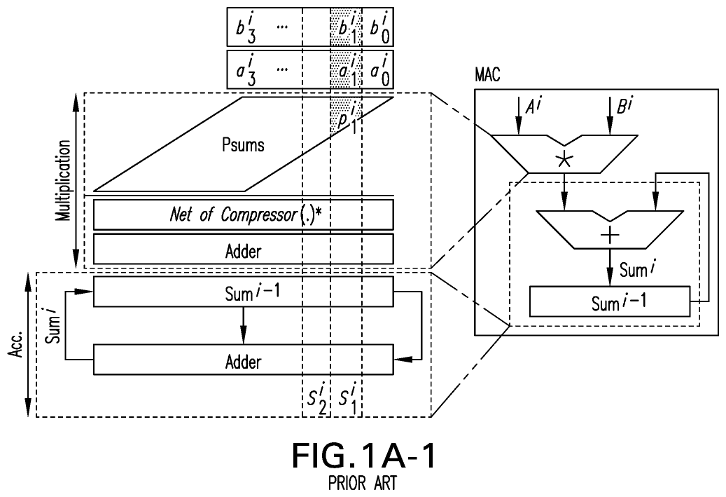

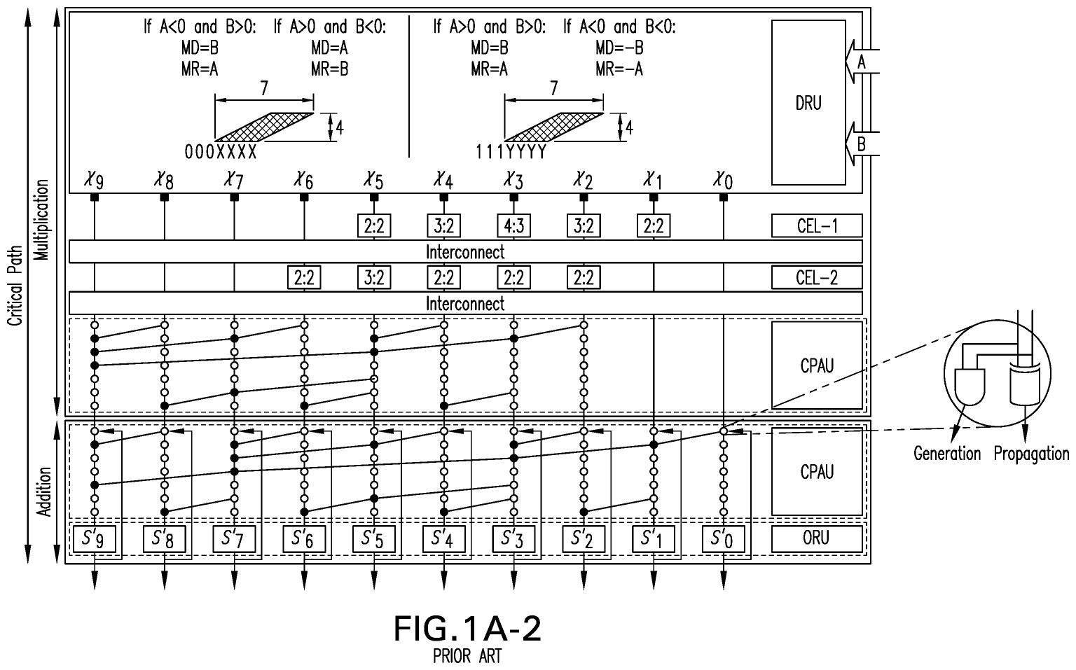

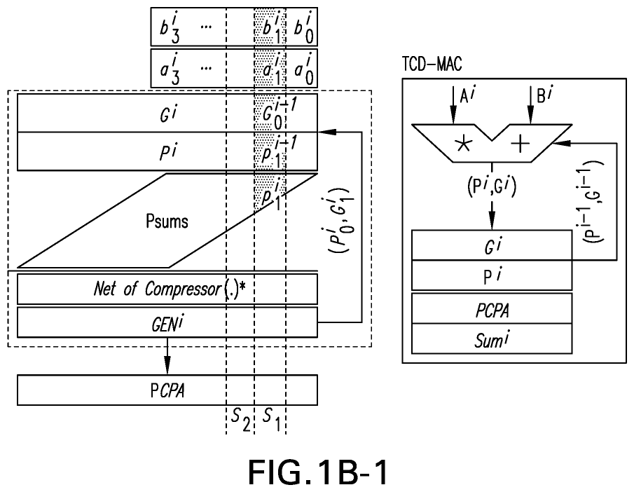

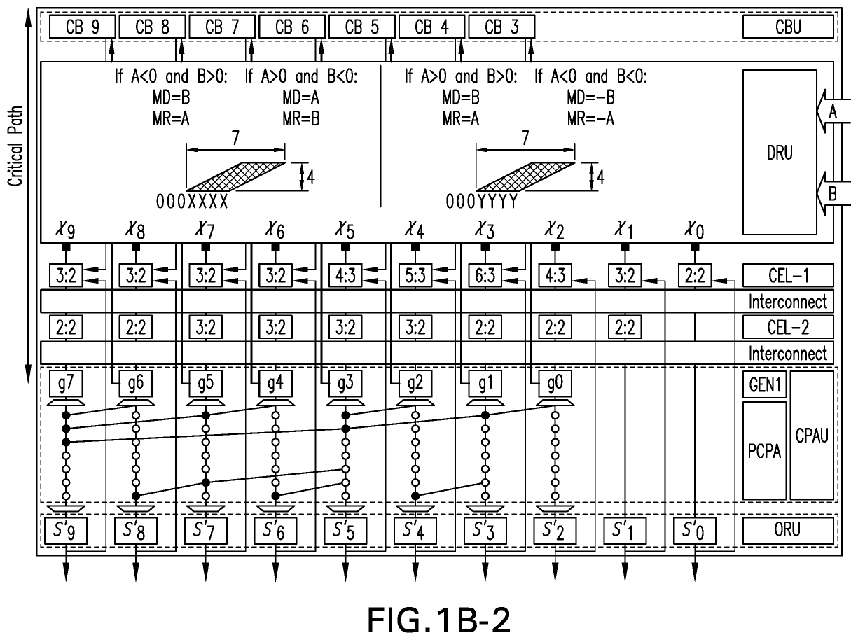

(similar to what is done during the activation process of each neuron in a NN). This could be achieved using a single Multiply-Accumulate (MAC) unit, by working on 2 inputs at a time for N rounds. FIG. 1A (top) shows the general view of a typical MAC architecture that is comprised of a multiplier and an adder (with 4-bit input width), while FIG. 1A (bottom) provides a more detailed view of this architecture. The partial products (M partial product for M-bits) are first generated in Data Reshape Unit (DRU). Then the Hamming Weight Compressors (HWC) in the Compression and Expansion Layer (CEL) transform the addition of M partial products into a single addition of two larger binaries, the addition of which in an adder generates the multiplication result.

The building block of the CEL unit, the HWC, denoted by C_{HW}(m:n), is a combinational logic that implements the Hamming Weight (HW) function for m input-bits (of the same bit-significance value) and generates an n-bit binary output. The output n of HWC is related to its input m by: n=┌log^{m}₂┐. For example “011010”, “111000”, and “000111” could be the input to a C_{HW}(6:3), and all three inputs generate the same Hamming weight value represented by “011”. A Completed HWC function CC_{HW}(m:n) is defined as a C_{HW} function, in which m is 2ₙ−1 (e.g., CC(3:2) or CC(7:3)). Each HWC takes a column of m input bits (of the same significance value) and generates its n-bit hamming weight. In the CEL unit, the output n-bits of each HWC is fed (according to its bit significance values) as an input to the proper C_{HW}(s) in the next-layer CEL. This process is repeated until each column contains no more than 2-bits, which is a proper input size for a simple adder. In FIG. 1A it is assumed that a Carry Propagation Adder Unit (CPAU) is used. The result is then added to the previously accumulated value in the output register in the second adder to a new accumulated sum. Note that in a conventional MAC, the carry (propagation) bits in the CPAUs are spatially propagated through the carry chain which constitutes the critical timing path for both adder and multiplier.

FIG. 1B shows the concept of our TCD-MAC.

In this solution, only a single CPAU is used, and a glue unit so called GENeration(GEN) is used as an interface that specifies those units that exist outside/inside the skip block in different mode of configuration of TCD-MAC. GEN has two parts G which contains only one bit in each bit-position of the output of the unit prior to GEN unit,i.e., CEL_{L}, and P which refers to all bits except those used in G part. The bits inside the G either feed to the Output Register Unit, temporal sum unit, or the skipped units. Similarly, the bits inside P either feed to the Carry Buffer Unit, temporal carry unit, or skipped units. For example, In the FIG. 1B, GEN lies between the first layer of CPAU and rest of it, i.e., CPAU is broken into two distinct segments: 1) The GEN and Partial CPA (PCPA) segment. So GEN produces the signals Gᵢ^{c} and Pᵢ^{c} for each bit position IO at cycle c. The TCD-MAC relies on the assumption that we only need to correctly compute the final result of multiplication and accumulation over an array of inputs (e.g., Σᵢ₌₀^{N-1} (Aᵢ*Bᵢ)), while relaxing the requirement for generating correct intermediate sums. This relaxed specification is applicable when a MAC is used to compute a Neuron value in a DNN. Benefitting from this relaxed requirement, the TCD-MAC skips the computation of PCPA, and injects (defers) the Gᵢ^{c}and Pᵢ^{c} signals generated in cycle c, to the CEL unit in cycle c+1. Using this approach, the propagation of carry-bit in the long carry chain (in PCPA) is skipped, and without loss of accuracy, the impact of the carry bit is injected to the correct bit position in the next cycle of computation. We refer to this process as temporal (in time) carry propagation. The Temporally carried Gᵢ^{c} signal is stored in a new set of registers denoted as Carry Buffer Unit (CBU), while the Pᵢ^{c} signal in each cycle is stored in the Output Register Unit (ORU). Note that CBU bits can be injected to any of the C_{HW}(m:n) in any of the CEL layers in the same bit position. However, it is desired to inject the CB bits to a C_{HW}(m : n) that is incomplete to avoid an increase in the size and critical path delay of the CEL.

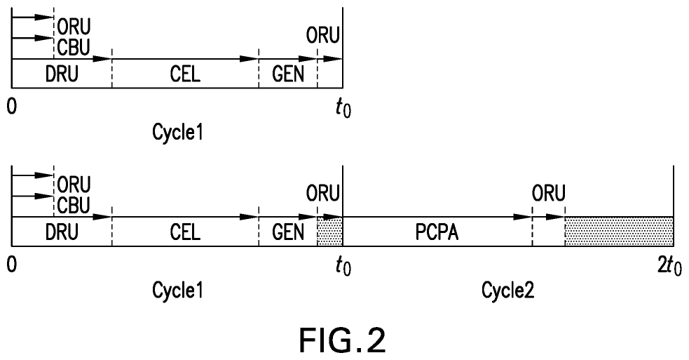

Assuming that a TCD-MAC works on an array of N input pairs, the temporal carry injection is done N−1 times. In the last round, however, the PCPA should be executed. As illustrated in FIG. 2, in this approach, the cycle time of the TCD-MAC could be reduced to that excluding the PCPA, allowing the computation over PCPA to take place in an extra cycle. The one extra cycle allows the unconsumed carry bits to be propagated in PCPA carry chain, forcing the TCD-MAC to generate the correct output. Using this technique we shortened the cycle time of TCD-MAC for a large number of cycles. The saving obtained from shorter cycles over a large number of cycles significantly outweighs the penalty of one extra cycle. Within the context of the invention any adder should be able to work in this architecture as a partial adder.

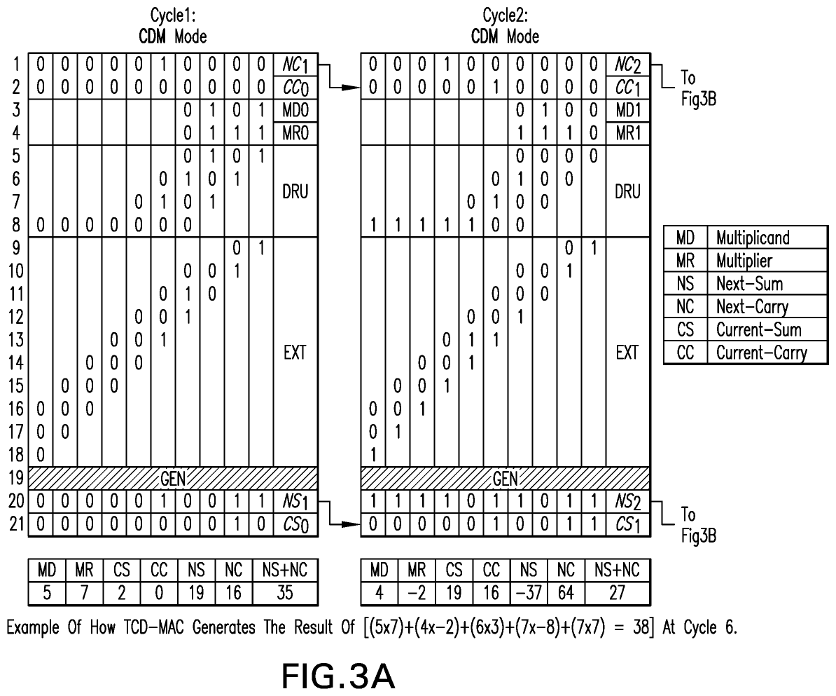

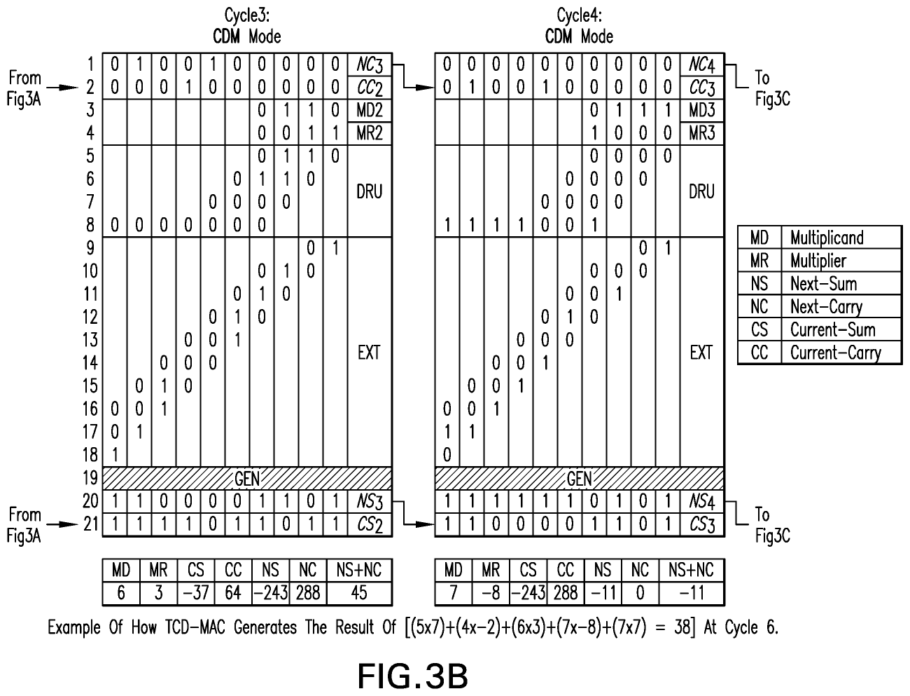

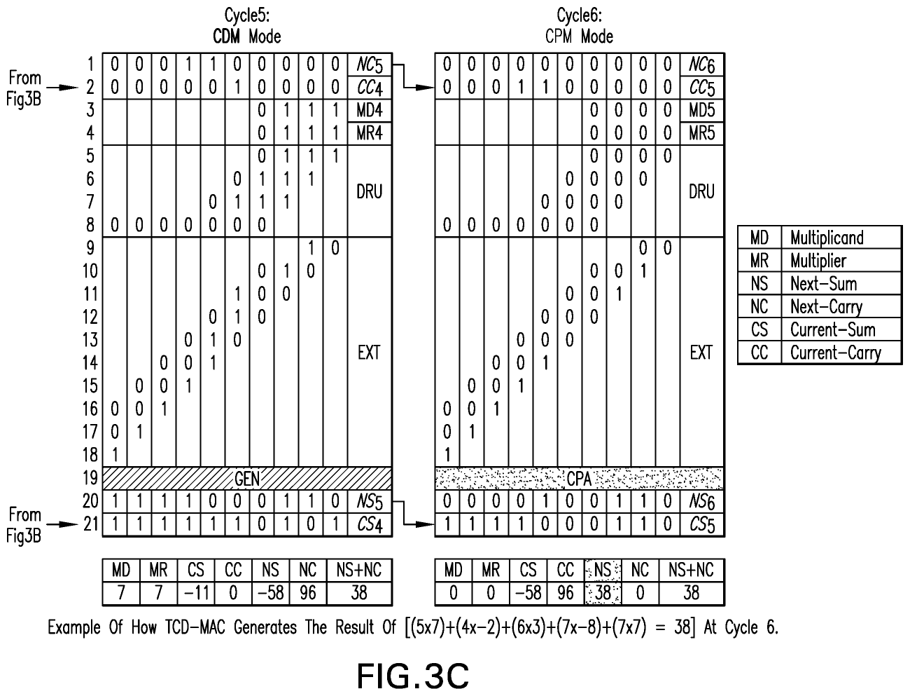

FIG. 3 illustrates an example of cycle by cycle execution of TCD-MAC to compute 5×7+4×−2+6×3+7×−8+7×7=38. For simplicity, we presented the case using 4-bit signed numbers. The figure captures the value of intermediate sum and temporal carry at each cycle. As illustrated, the raw value of intermediate sums in TCD-MAC are incorrect, however, after taking one extra (last) cycle to propagate the remaining carry bits, it produces the correct output.

To support signed inputs, in TCD-MAC we pre-process the input data. For a partial product p=a×b, if one value (a or b) is negative, it is used as the multiplier. With this arrangement, we treat the generated partial sums as positive values and later correct this assumption by adding the two's complement of the multiplicand during the last step of generating the partial sum. This feature is built into the architecture using a simple 1-bit sign detection unit. The following example will clarify this concept: let's suppose that a is a positive and b is a negative b-bit binary. The multiplication b x a can be reformulated as:

$$b \times a = ( - {2}^{7} + {\sum }_{i = 0}^{6} {x}_{i} {2}^{i} ) \times a = - {2}^{7} a + ( {\sum }_{i = 0}^{6} {x}_{i} {2}^{i} ) \times a \qquad ( 1 )$$

The term −2⁷a is the two's complement of multiplicand which is left-shifted by 7 bits, and the term (Σᵢ₌₀⁶xᵢ2ⁱ)×a is only accumulating shifted version of the multiplicand.

FIG. 1B shows a simplified version of our Neural Engine, Exploiting Spatial Locality of Data and Temporal Continuity of Computation for Acceleration (NESTA). NESTA intertwines the multiplication and addition and reduces the delay of Carry Propagation Adder (CPA) by using the GEN section inside the CPA. The GEN section only produces the first level generate Gi and propagate Pi signals, after which TSC-MAC feeds back inclusion in the computation of the next set of data. We can consider this as the process of generating a temporal carry signal, as opposed to a spatial carry signal which is used in typical MACs. This is made possible, considering that we do not need the output of individual multiplications, and our target is to compute the correct Σᵢ₌₀^{N-1} (Aᵢ*Bᵢ). Hence, in TCD-MAC for N−1 times, only the GEN section of CPA is executed, while for the last iteration, the complete CPA is executed (including PCPA) to avoid generating further temporal bits.

Let's consider an application that requires hardware acceleration for computing the following expression: p=Σᵢ₌₁⁹aᵢ, in which aᵢ(s) are 16-bit unsigned numbers. One natural solution is using an adder-tree, while each operator could be implemented using a fast adder such as carry-look-ahead (CLA). Regardless of the choice of adder, the resulting adder tree is not the most efficient. The adder power delay product (PDP) could significantly improve if a multi-input adder is reconstructed using Hamming Weight (HW) compressors. For this purpose, we reformulate the computation of p as shown in Equation 2 by rearranging the values into 16 array of 9 bits with equal significance value and use a hierarchy of Hamming Weight compressors to perform the addition.

$$p = {\sum }_{i = 0}^{15} {\sum }_{j = 1}^{9} ( {2}^{i} \& {a}_{j} ) \qquad ( 2 )$$

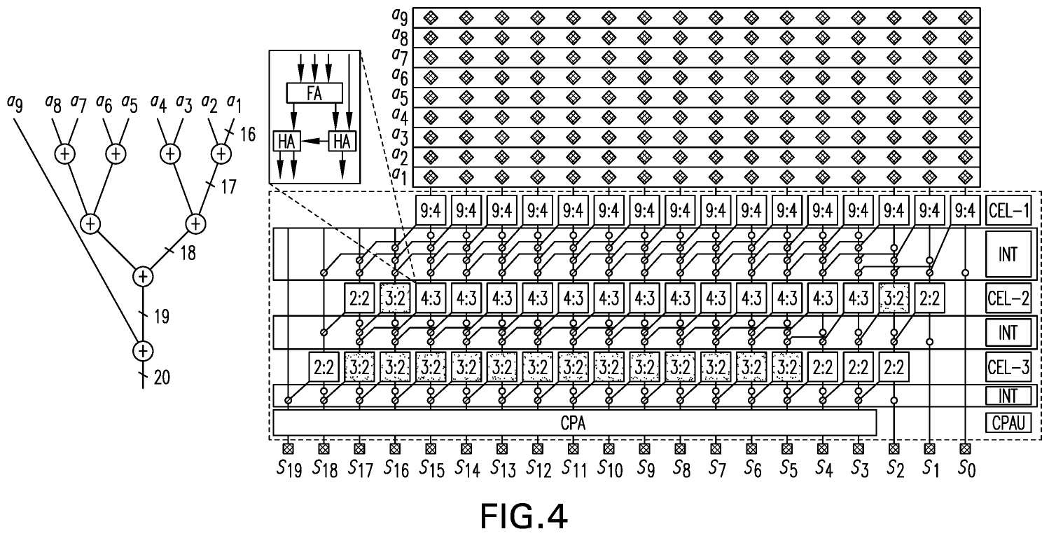

FIG. 4 shows the structure of the HW compression Adder (HWC-Adder), which is composed of four stages. In each of the first three stages, the HW compressors C(m:n) take m bit values of the same significance (shown vertically) and computing their HW value (of size n) which is expanded vertically. Aligning the bit values of the same significance generates a smaller stack of bit values at each bit position as input to the next level of compressors. We refer to each of these stages (stages 1 to 3) as Compression and Expansion Layer (CEL). In the last stage, every bit-column contains no more than two bits. In this stage, a simple 2-input addition generates the final results.

NESTA is one of the applications that we employed TCD-MAC for calculating Convolutional Neural Networks i.e., NESTA is a specialized neural processing engine designed for executing learning models in which filter-weights, input data, and applied biases are expressed in fixed-point format. NESTA uses TCD-MAC in a 3×3 kernel window, meaning, nine multiplications and nine additions into one batch-operation for gaining energy and performance benefits. Let's assume the used TCD-MAC_{ACC} is the current accumulated value, while I and W represent the input values and filter weights, respectively. In the nₜₕ round of execution, the following operation is performed (TCD-MAC_{ACC}):

$$TCD - {MAC}_{ACC} ( n ) = TCD - {MAC}_{ACC} ( n - 1 ) + {\sum }_{i = 9 n}^{9 n + 9} {I}_{i} \times {W}_{i} \qquad ( 3 )$$

More precisely, in each cycle c, after consuming nine input-pairs (weight and input), instead of computing the correct accumulated sum, NESTA quickly computes an approximate partial sum S′[c] and a carry C[c] such that S[c]=S′[c]+C[c]. The S′[c] is the collection of generated bits (Gᵢ) and C[c] is the collection of propagated (Pᵢ) bits produced by GEN unit. The S′[c] is saved in the output registers, while the C[c] are stored in Carry Buffer Unit (CBU) registers. In the next cycle, both S′[c] and C[c] are used as additional inputs (along with nine new inputs and weights) to the CEL unit. Saving the carry (propagate) values (Ps) in CBU and using them in the next iteration reflects the temporal carry concept, in which the reuse of S′ in the next round implements the accumulation function of NESTA.

In the last cycle, when working on the last batch of inputs, NESTA computes the correct S[c] by using the PCPA to consume the remaining carry bits and by performing the complete addition S[c]=S′[c]+C[c]. Note that the add operation generates a correct partial sum whenever executed. But, to avoid the delay of the add operation, NESTA postpones it until the last cycle. For example, when processing a 11×11 convolution across ten channels, to compute each value in Ofmap, 1210 (11×11×10) MAC operations are needed. To compute this convolution, NESTA is used 135 times ┌1210/9┐, followed by one single add operation at the end to generate the correct output.

To improve efficiency, NESTA does not use adders and multipliers. Instead, it uses a sequence of Hamming weight compressions followed by a single add operation. Furthermore, in each cycle c, after consuming nine input-pairs (weight and input), instead of computing the correct accumulated sum, NESTA quickly computes an approximate partial sum S′[c] and a carry C[c] such that S[c]=S′[c]+C[c]. The S′[c] is the collection of generated bits (Gᵢ) and C[c] is the collection of propagated (Pᵢ) bits produced by the GEN unit. Note that the division of CPA into GEN and PCPA was described above with respect to FIG. 1B. The S′[c] is saved in the output registers, while the C[c] are stored in the Carry Buffer Unit (CBU) registers. In the next cycle, both S′[c] and C[c] are used as additional inputs (along with nine new inputs and weights) to the CEL unit. Saving the carry (propagate) values (PS) in CBU and using them in the next iteration reflects the temporal carry concept that is described above, while reuse of S′ in the next round implements the accumulation function of TCD-MAC.

In the last cycle, when NESTA is working on the last batch of inputs, the used TCD-MACs computes the correct S[c] by using the PCPA to consume the remaining carry signals and by performing the computed addition S[c]=S′[c]+C[c]. Note that the add operation generates a correct partial sum whenever executed, but to avoid the delay of the add operation, TCD-MAC postpones it until the last cycle. For example, when processing a 11×11 convolution across 10 channels, to compute each value in Ofmap, 1210 (11×11×10) MAC operations are needed. To compute this convolution, NESTA is used 135 times [1210/9], followed by one single add operation at the end to generate the correct output.

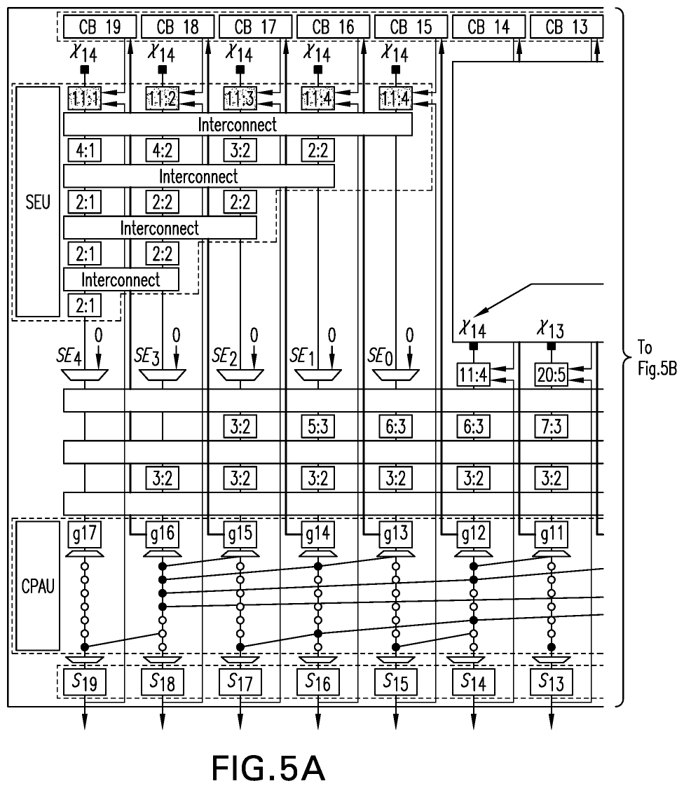

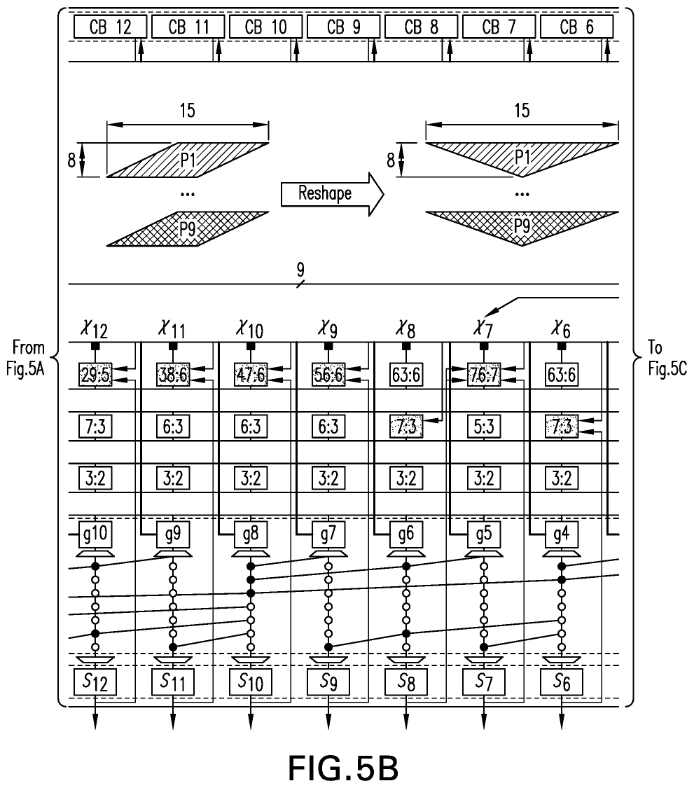

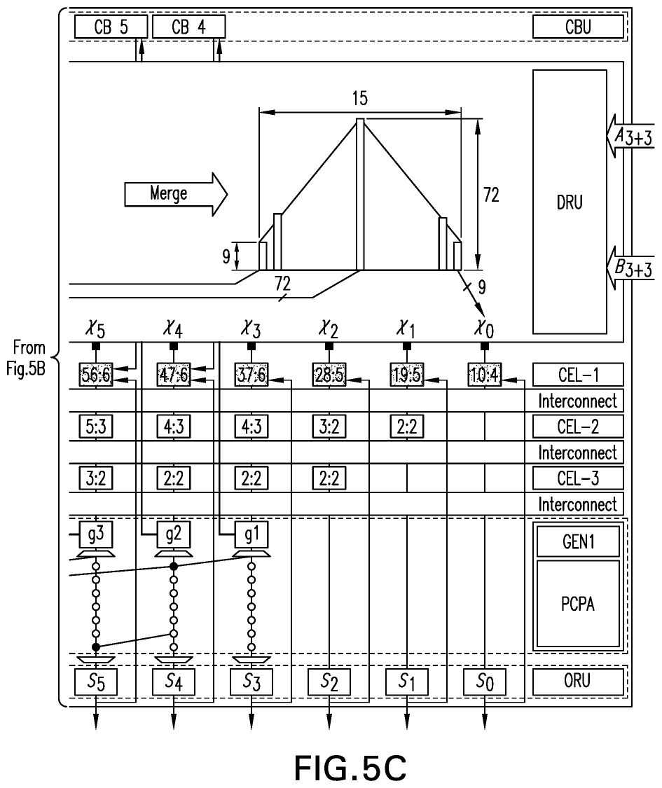

FIG. 5 shows the NESTA architecture. It is comprised of six units: 1) Data Reshaping Unit (DRU), 2) Sign Expansion Unit (SEU), 3) Compression and Expansion Layers (CEL), 4) Adder Unit (AU), 5) Carry Buffer Unit (CBU), 6) Output Register Unit (ORU), and 7) Generation Unit (GEN).

The Data Reshape Unit (DRU) receives nine pair of multiplicands and multipliers (W and I), converts each multiplication to a sequence of additions by ANDing each bit value of multiplier with the multiplicand and shifting the resulting binary by the appropriate amount and returns bit-aligned version of the resulting partial products, M₀. Because the size of results varies for computing the large number of values the precision of NESTA has been increased by m bits. j is the number of bits involved in bit-position i of D₀ can be calculated by the equation 4:

$$j = \{ \begin{matrix}9 * ( i + 1 ) & i ∈ [ 0 , N - 1 ] \\ 9 * ( 2 N - i - 1 ) & i ∈ [ N , 2 N - 2 ] \\ 9 & i ∈ [ 2 N - 1 , 2 N + m - 1 ]\end{matrix} \qquad ( 4 )$$

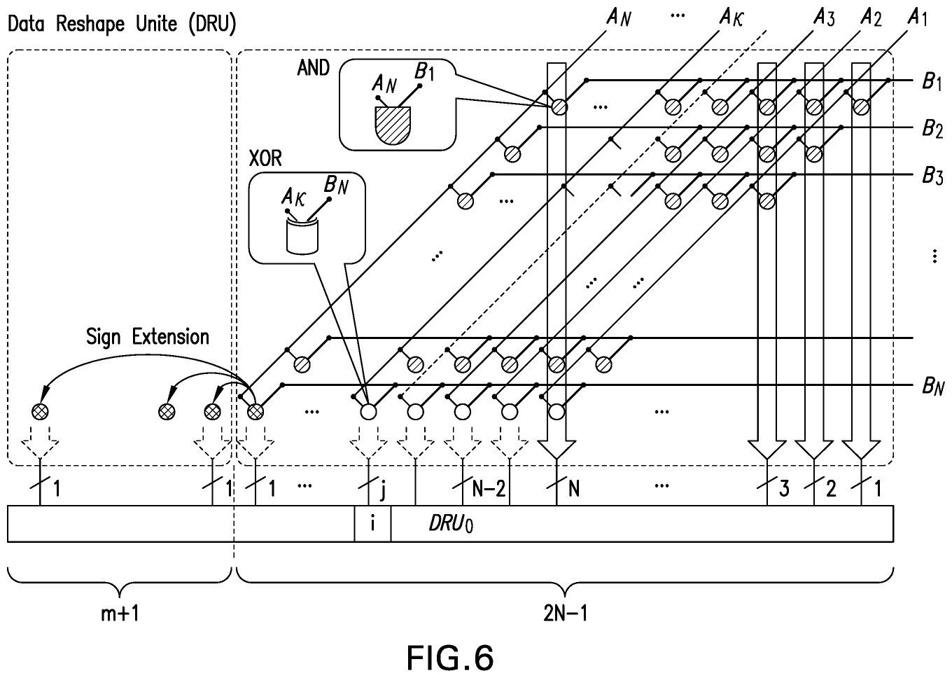

FIG. 6 is a diagram of the detailed structure of the Data Reshape Unit (DRU) of TCD-MAC, in 1×1 kernel-window configuration, for two N-bit fixed-point values A and B. The shaded circles are bit-wise AND gates and the black circles are bit-wise XOR gates. D₀ is the output of the DRU.

The Sign Extension Unit (SEU) is responsible for producing sign bits SE₀ to SE₄. The inputs to the SEU is sign bit (X₁₄). The result of a multiplying and adding nine 8-bit values is at most twenty bits. Hence, we need to sign-extend each one of the 15-bit partial sums (for supporting larger, the architecture is modified accordingly). In order to support signed inputs, we also need to slightly change the input data representation. For a partial product p=a×b, if one of the values a or b is negative, we need to make sure that the negative number is used as the multiplier and the positive one as the multiplicand. With this arrangement, we treat the generated partial sums as positive values, and make a correction for this assumption by adding the two's complement of the multiplicand during the last step of generating the partial sum. This feature is built into the architecture using a simple 1-bit sign detection unit and by adding multiplexers to the output of input registers to capture the sign bits. Note that multiplexers are only needed for the last five bits. The following example will clarify this concept. Let's suppose that a is a positive and b is a negative b-bit binary. The multiplication b×a can be reformulated as Equation (1).

The term 2⁷a is the two's complement of the multiplicand which is shifted to the left by seven bits, and the term (Σᵢ₌₀⁶xᵢ2ⁱ)×a is only the accumulating shifted version of the multiplicand. Note that some of the output bits generated by the SEU compressor extend beyond twenty required bits. These sign bits are safely ignored. Finally, the multiplexers switch at the output of the SEU is used to allow NESTA to switch between signed and unsigned modes of operation.

The input to the i^{th} bit of the Compressions and Expansion Layers (CEL) in cycle n is, first, the bit-aligned partial sums (at the output of the DRU) in position I, second, the temporary sum generated by the GEN unit of NESTA at time c-1 at bit position I, and third, Propagate (carry) value generated by the GEN unit of NESTA at time c-1 at bit position i-1. Following the concept of HWC-Adder, the CEL is constructed using a network of Hamming Weight Compressors (HWC). A HWC function C_{HW}(m:n) is defined as the Hamming Weight (HW) of m input bits (of the same bit-significance value) which is represented by an n-bit binary number, where n is related to m by n=└log₂^{m}┘+1. For example, “011010”, “111000”, and “000111” could be the input to a C_{HW}(6:3), and all three inputs generate the same Hamming weight value represented by “011”. A completed HWC function CC_{HW}(m:n) is defined as a C_{HW} function, in which m is 2ⁿ−1 (e.g., CC(3:2) or CC(15:4)). As illustrated in FIG. 5, each HWC takes a column of m input bits (of the same significance value) and generates its n-bit Hamming weight. The resulting n bits is then horizontally distributed as input to C_{HW}(s) in the next layer CEL. This process is repeated until each column contains no more than two bits.

Similar to the HWC-Adder, The Carry Propagation Adder Unit (CPAU) is divided into GEN and PCPA. If NESTA is executed n times, the PCPA is skipped n−1 times and is only executed in the last iteration. GEN is the first logic level of CPA executing the generate and propagate functions to produce temporary sum/generate G and carry/propagate P which are used as input in the next cycle.

The Carry Buffer Unit (CBU) is a set of registers that store the propagate/carry bits generated by GEN at each cycle and provide this value to the CEL unit in the next cycle. Note that the CB bits can be injected to any of the C_{HW}(m:n) in any of the CEL layers in that bit position. Hence, it is desired to inject the CB bits to a C_{HW}(m:n) that is incomplete to avoid an increase in the size and critical path delay of the CEL.

The Output Register Unit (ORU) captures the output of GEN in the first n−1 cycles of PCPA in the last cycle of operation. Hence, in the first n−1 cycles of the NESTA execution it stores the Generate (G) output of GEN unit and feeds this value back to the CEL unit in the next cycle, it stores the sum generated by PCPA.

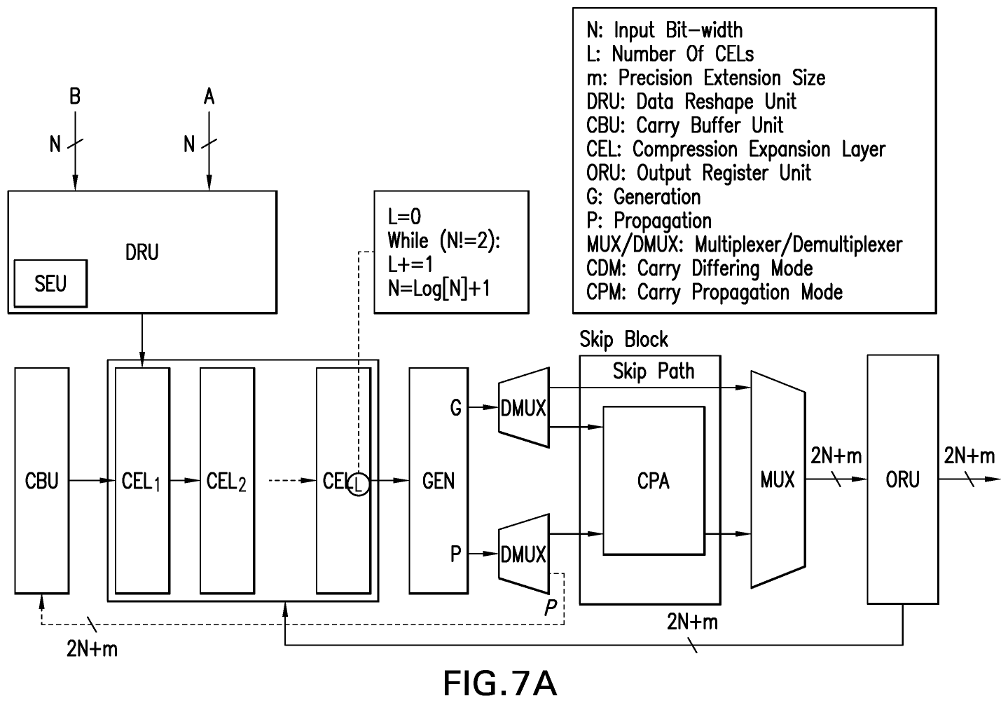

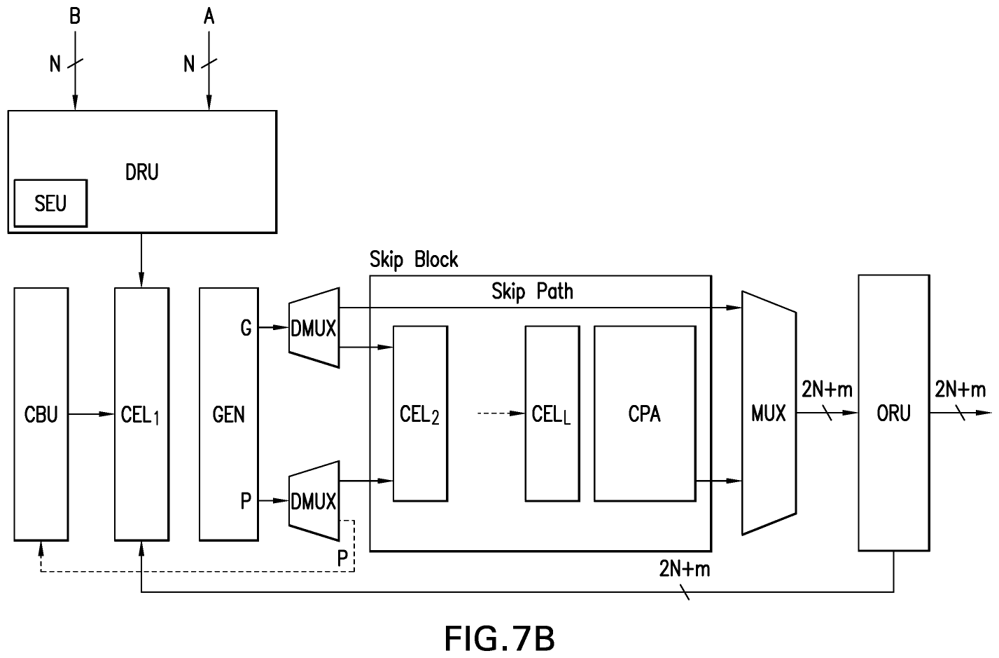

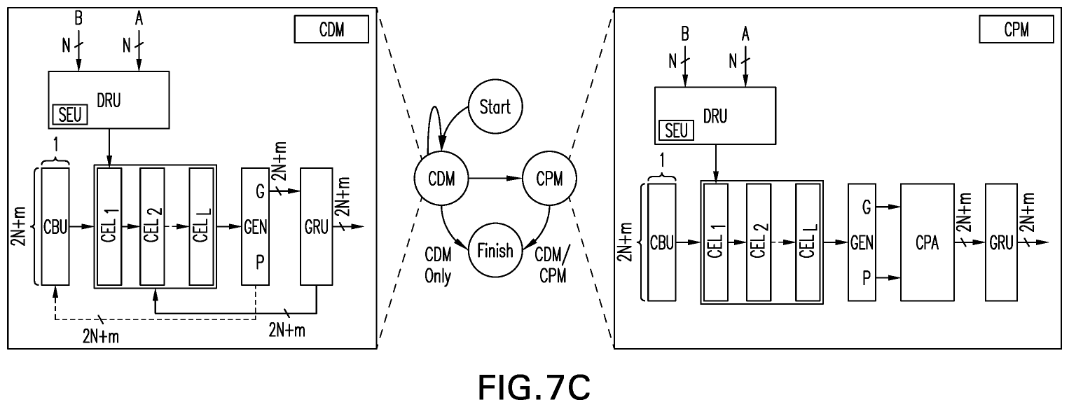

As illustrated in FIGS. 7A and 7B, NESTA can be operated in two modes at each operation cycle: 1) Carry Deferring Mode (CDM), or 2) Carry Propagation Mode (CPM). When working with an input stream of size n, following scenarios can happen: 1) TCD-MAC entirely operates in CDM mode for at most n+2N−L cycles, in which L is the number of CELs, to generate the accurate result 2) TCD-MAC operates in CDM mode for n cycles and in the CPM mode in the last cycle to generate the accurate output. The major difference between the CDM and CPM mode is whether a skip path is being activated or not; i.e., when the skip path is activated TCD-MAC operates in CDM (shorter critical path) otherwise it operates in CPM (longer critical path). For example, FIG. 7C is related to the mode of operations of the TCD-MAC in FIG. 7A. As shown in this Figure, at the start, TCD-MAC stays inside the CDM mode for n−1 cycles, then based on the path to the finish state, TCD-MAC either is transited to CPM state for cycles n and n+1 or remains for 2N−L extra cycles in CDM state before generating the accurate results. Similar state diagram can be extracted for 7B and other design spaces of TCD-MAC in which the control flow of the underlying design can be specified based on that.

The TCD-MAC architecture can be modified from two design aspects: 1) Varying CDM in which, based on the design constraint, CDM can be longer or shorter. 2) Varying the capacity of calculations, in which multiple MAC operations will be done at once; i.e., scaling up the number of inputs and bit-width of each one based on the problem criteria.

Putting it all together, TDC-MAC receives nine pairs of Ws and Is. The DRU generates the partial products and bit-aligns them as input to the CEL unit. The CEL unit at each round of computation consumes bit values generated by the DRU, generates (temporary sum) values stored at S registers, and propagates (carry) bits in CB registers. This is when the SEU assures that the sign bits are properly generated. For the first n cycles, only the GEN unit of CPA is executed. This allows TCD-MAC to skip the delay of the carry chain of the PCPA. To be efficient, the clock period of TCD-MAC is reduced to exclude the time needed for the execution of PCPA. The timing paths in PCPA are defined as multi-cycle paths (two cycle paths). Hence, the execution of the last cycle of TCD-MAC takes two cycles. In the last round of execution, the PCPA unit is activated, allowing the addition of stored values in S registers and CB registers to take place for producing the correct and final SUM. Considering that the number of channels in each layer of modern CNNs is fairly large (128 to 512) the savings in the result of shortening TCD-MAC cycle time (by excluding PCPA) accumulated over large number of cycles (of TCD-MAC execution) is far larger than one additional cycle needed at the end to execute the PCPA for producing the correct final sum.

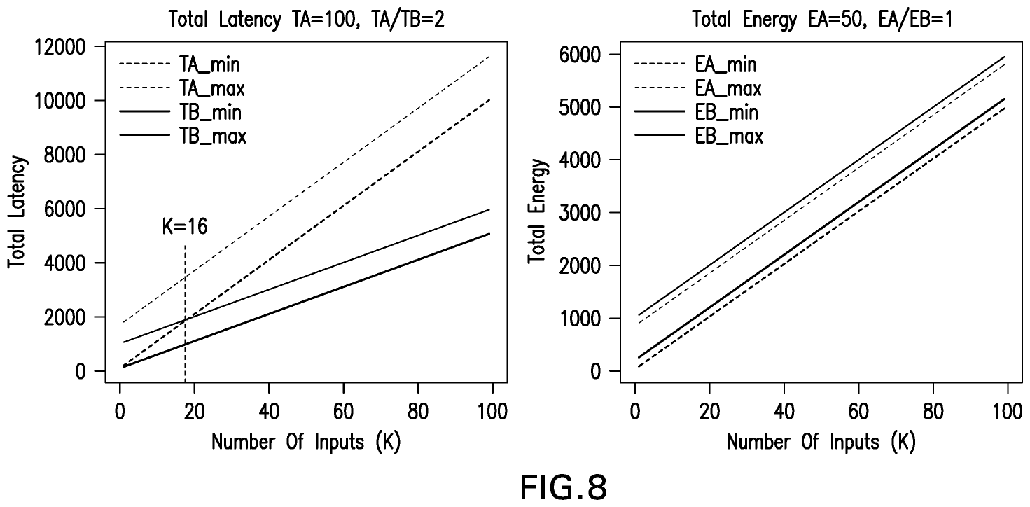

Depending on which components of TCD-MAC lies inside the skip block, CDM's latency can be defined. For example in the FIGS. 7A and 7B two scenarios are shown. In the scenario FIG. 7A, only the adder can be bypassed by the skip path, however in the scenario FIG. 7B not only the adder but also the CEL₁ to CEL_{L} can be skipped. Comparing these two scenarios we can observe that the latency of CDM in the scenario FIG. 7A, T_{A}, is much larger than the latter one, T_{B}. At the same time number of extra rounds in the scenario FIG. 7A changes in the range [1, 2N−L]; however, in the latter one the number of extra rounds changes in the range [2, 2N]. For an example, let's assume K=100 is the number of MAC operations on 8-bit values, N=8, with 4 precision bits, m=4, which needs to be done by these two scenarios. We also know that T_{A}=100 and T_{A}=2T_{B}. So the total latency to generate the results for scenarios FIG. 7A and 7B are in range [(K+1)*T_{A}, (K+13)*T_{A}] and [(K+2)*T_{B}, (K+16)*T_{B}], respectively. For investigating the effect of K on the total latency we swept K in range [1, 100] as shown in FIG. 8. By this setup, by increasing K more than 16, scenario FIG. 7A always outperforms the scenario FIG. 7B, but below the number 16, scenario FIG. 7A in its minimum-rounds setup outperforms scenario FIG. 7B in its maximum-rounds setup. Similarly, the effect of increasing K on the total energy consumption has been investigated in FIG. 8. In the example, let's assume energy consumption in the CDM part for both scenarios are E_{A}=E_{B}=50; however, the energy consumption of the skip block in scenario FIG. 7A is almost half of the skip path of scenario FIG. 7B. So the range of energy consumption for scenarios FIGS. 7A and 7B are
[E_{A-CDM}*K+E_{A-skip}, (K+13)*E_{A-CDM}], and
[E_{B-CDM}*K+E_{B-skip}, (K+16)*E_{B-CDM}], respectively.
   By drawing the minimum and maximum energy consumption of each scenarios, we observe that minimum energy consumption of scenario FIG. 7A is always less than scenario FIG. 7B, but still there is an overlap between the range of energy-consumption of these two scenarios.

By having these figures a designer can easily select the right scenario of NESTA that suits the underlying application. Note that these analysis were for only two of the possible design space of NESTA, in fact based on the portion of NESTA that poses inside the skip-path a new design space can be extracted.

The TCD-NPE, is a configurable neural processing engine which is composed of a 2-D array of TCD-MACs. The TCD-MAC array is connected to a global buffer using a configurable Network on Chip (NOC) that supports various forms of data flow as described above. However, for simplicity, we limit our discussion to supporting OS and NLR data flows for executing MLPs. This choice is made to help us focus on the performance and energy impact of utilizing TCD-MACs in designing an efficient NPE without complicating the discussion with the support of many different data flows.

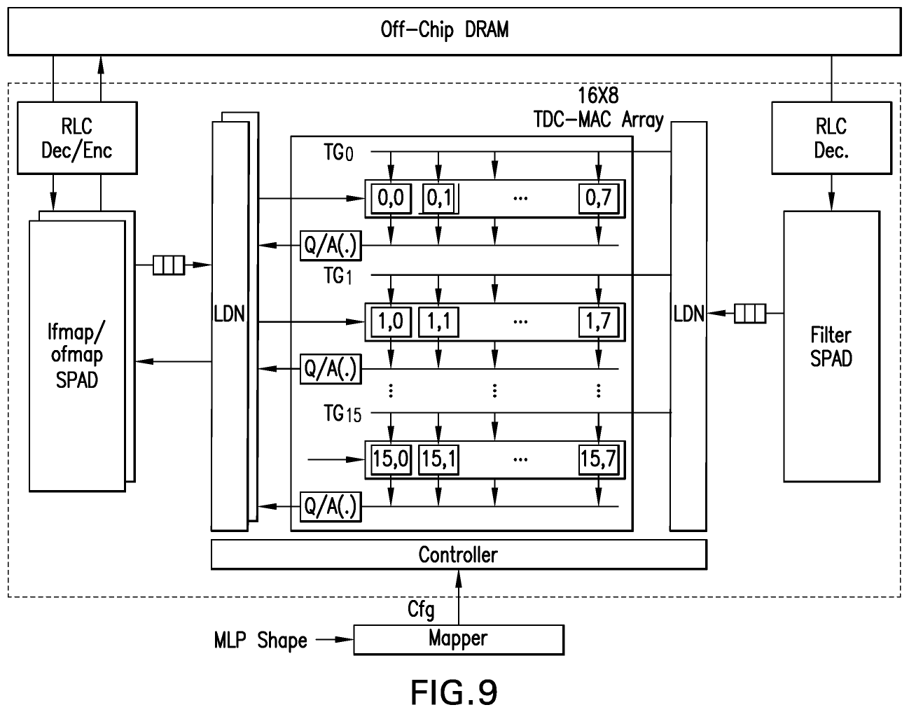

FIG. 9 captures the overall TCD-NPE architecture. It is composed of a Processing Element (PE) array which is a tiled array of TCD-MACs, Local Distribution Network (LDN) that manages the PE-array connectivity to memories, two global buffers, one for storing the filter weights and one for storing the feature maps, and the Mapper-and-controller unit which translates the MLP model into a supported data and control flow. The functionality and design of each of these units are described next.

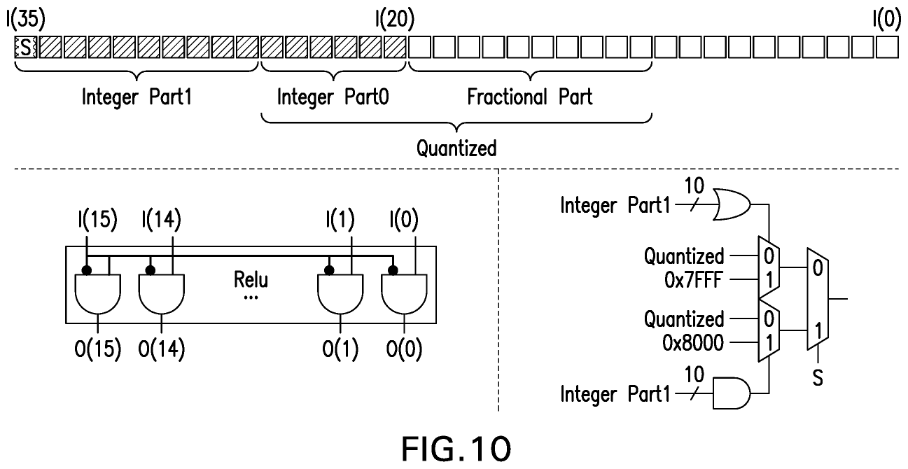

The PE-array is the computational engine of our TCD-NPE. Each PE in this tiled array is a TCD-MAC. Each TCD-MAC could be operated in two modes: Carry Deferring Mode (CDM), or Carry Propagation Mode (CPM). When working with an input stream of size N (e.g., when there are N neurons in the previous layer of MLP, and a TCD-MAC is used to compute a Neuron value in the next layer), the TCD-MAC is operated in the CDM model for N cycles (computing approximate sum), and in the CPM mode in the last cycle to generate the correct output and insert it on the NoC bus for write to memory (or to be used as input by other PEs). This is in line with OS data flow. Note that the TCD-MAC in this PE-array could be operated in CPM mode in every cycle allowing the same PE-array architecture to also support the NLR. After computing the raw neuron value (prior to activation), the TCD-MAC writes the computed sum into the NoC bus. The Neuron value is then passed to the quantization and activation unit before being written back to the global buffer. FIG. 10 captures the logic implementation for quantization (to 16 bits) and Relu activation in this unit.

Consider two layers of an MLP where the input layer contains M feature-values (neurons) and the second layer contains N Neurons. To compute the value of N Neurons, we need to utilize N TCD-MACs (each for M+1 cycles). If the number of available TCD-MACS is smaller than N, the computation of the neurons in the second layer should be unrolled to multiple rolls (rounds). If the number of available TCD-MACs is larger than neurons in the second layer (for small models), we can simultaneously process multiple batches (of the model) to increase the NPE utilization. Note that the size of the input layer (M) will not affect the number of needed TCD-MACs, but dictates how many cycles (M+1) are needed for the computation of each neuron.

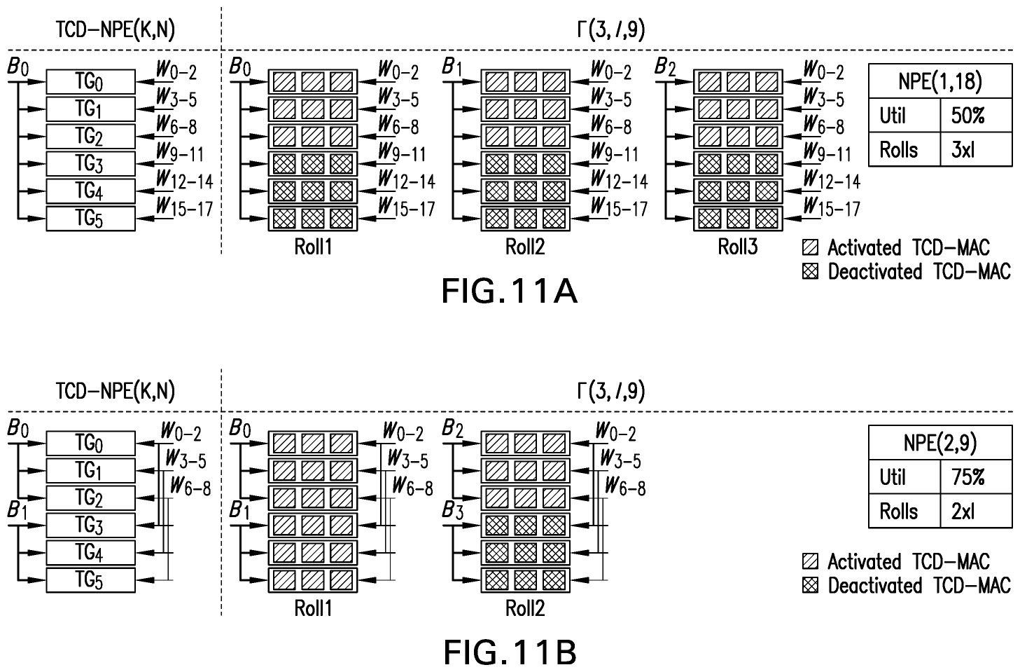

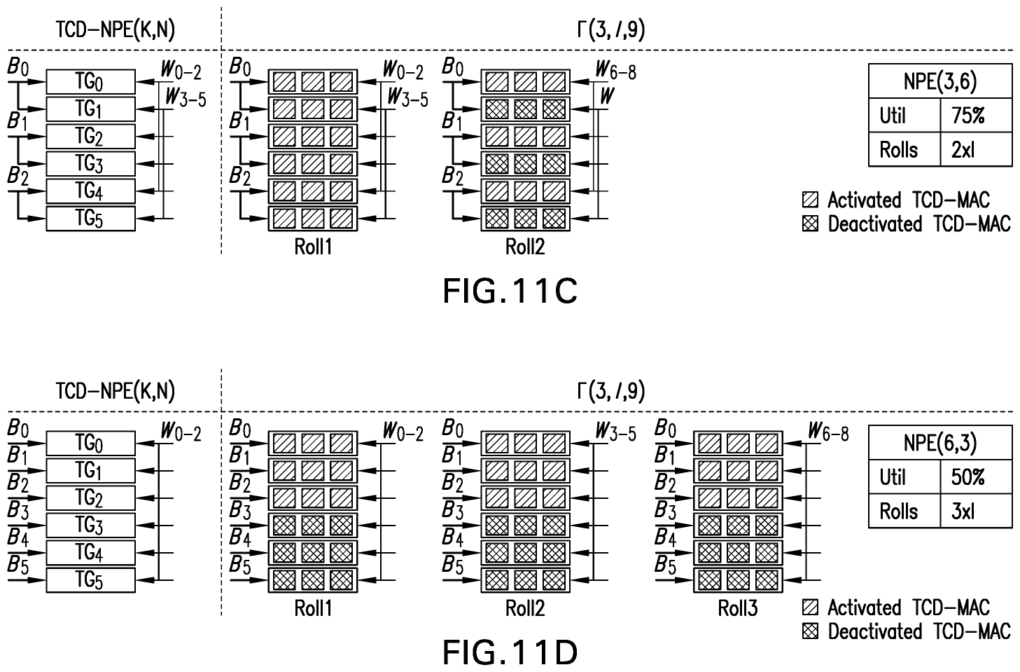

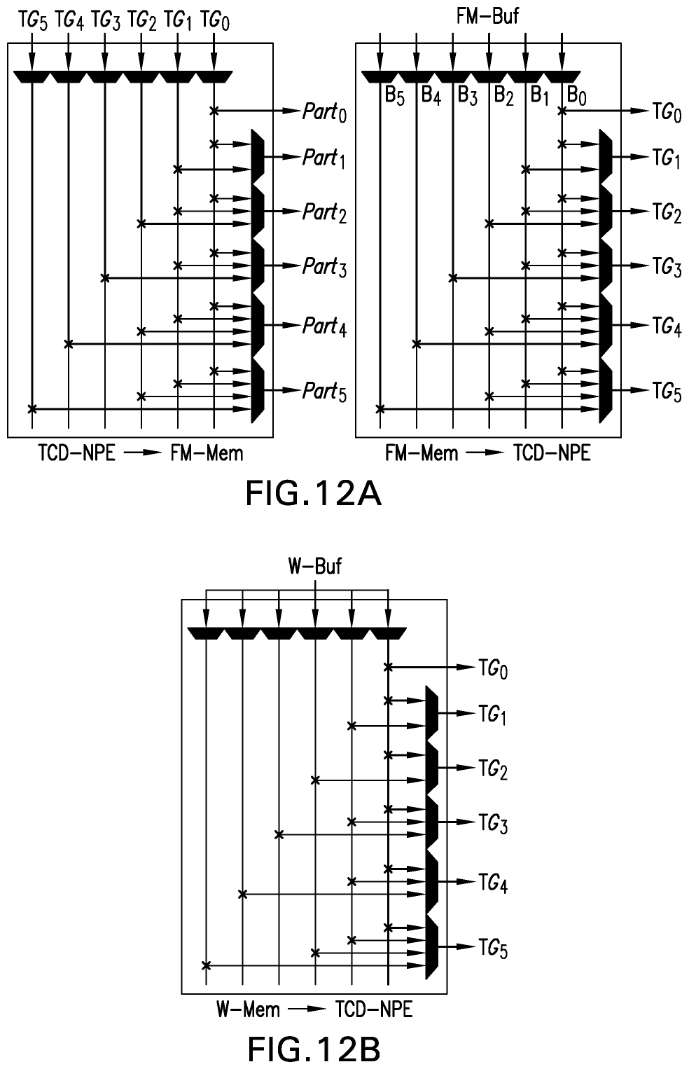

When mapping a batch of MLP to the PE-array, we should decide how the computation is unrolled and how many batches (K), and how many output neurons (N) should be mapped to the PE-array in each roll. The optimal choice would result in the least number of rolls and the maximum utilization of the NPE when processing across all batches. To illustrate the trade-offs in choosing the value of (K, N) let us consider a PE-array of size 18, which is arranged in six rows and three columns of TCD-MACs (similar to that in FIG. 11). We refer to each row of TCD-MACs as a TCD-MAC Group (TG). In our implementation, to reduce NoC complexity, the TG groups work on computing neurons in the same batch, while different TG groups could be assigned to work on the same or different batches. The architecture in FIG. 12 has six TG groups. Let us use NPE(K, N) to denote the choice of using the PE-array to compute N neuron values in K batches where N=18. In our example 6×3 PE-array can support the following selections of K and N: (K,N)∈(1,18), (2, 9), (3, 6), (6, 3). Note that the (9,2) and (18,1) configuration are not supported as the value of N in this configurations is smaller in size than TG (which is three).

FIG. 11 top shows an abstract view of TCD-NPE and illustrates how the weights and input features (from one or more batches) are fed to the TCD-NPE for different choices of K and N. As an example, FIG. 11 top shows that input features from one batch are broadcasted between all TGs, while the weights are unicasted to each TCD-MAC. Let us represent the input scenario of processing B batches of U neurons in a hidden or output layer of an MLP model using F(B,U). FIG. 11 bottom shows the NPE status when a F(3,9) model (3 batches of a hidden layer with nine neurons in an MLP model) is executed using each of 6 different NPE(K, N) choices. For example, FIG. 11 bottom shows that using configuration NPE(1,18), we process one batch with 18 neurons at a time. In this example, when using this configuration, the NPE is underutilized (50%) as there exist only 9 neurons in each batch. Following a similar argument, the NPE(6,3) arrangement also have 50% utilization. However the arrangement NPE(2,9), and NPE(3,6) reach 75% utilization (100% for the roll, and 50% for the second roll), hence either NPE(2,9) or NPE(3,6) arrangement is optimal for the F(3,9) problem as they unrolled the problem into two rolls while the other two underutilized NPE configurations unrolled the problem into three rolls.

An MLP has one or more hidden layers and could be presented using Model (I H₁—H₂— . . . —H_{N}—O), in which I is the number of input features, Hᵢ is the number of Neurons in the hidden layer i, and O is the number of output layer neurons. The role of the mapping unit is to find the best unrolling scenario for mapping the sequence of problems Γ(B, H₁), Γ(B, H₂), . . . , Γ(B, H_{N}), and Γ(B, O) into minimum number of NPE(K,N) computational rounds.

Algorithm 1 describes the mapper function for unrolling a multi-batch multi-layer MLP problem. In this Algorithm, B is the batch size that could fit in the NPE's feature-memory (if larger, we can unroll the B into N×B* computation round, where B* is the number of batches that fit in the memory). M[L] is the MLP layer size information, where M[i] is the number of nodes in layer i (with i=0 being Input, and i=N+1 being Output, and all others are hidden layers). The algorithm schedules a sequence of NPE(K, N) events to compute each MLP layer across all batches.

Algorithm 1
Schedule NPE(K,N) rolls (events to execute B batches
of M(L) = MLP(I, H₁, . . . , Hₙ, O)

procedure PRACTICALCFGFINDER (Model M[L], BatchSize B)

for (l = 1; size(M); l + +) do

Tree_{head} = CreateTree(B, M[l])
Exec_{Tree} ← Shallowest binary tree (least rolls) from Tree_{head}
Schedule ← Schedule computational events by using BFS

on Exec_{Tree} to report NPE(K,N) and r at each node.

return Schedule

procedure Create_{Tree} (B, Θ)

C[i] ← find each (Kᵢ, Nᵢ) | Kᵢ, Nᵢ ϵ, [symbol] , & Kᵢ < B

& size (NPE) = Kᵢ × Nᵢ

for (i=0; i < size(C); i + +) do

M_{B} = min(B, C[i][1]).
M_{Θ} = min(Θ, C[i][2]).
ψ = (M_{B}, M_{Θ})
r = └B/M_{B}┘ × └Θ/M_{Θ} ┘

if (B%M_{B}) ! = 0 then

Node_{B} ← CreateTree(B% M_{B}, Θ)

if (K%M_{Θ}) ! = 0 then

Node_{Θ} ← CreateTree(B%M_{B}, Θ)

Node createNode ®, ψ, Node_{B}, Node_{Θ})

return Node

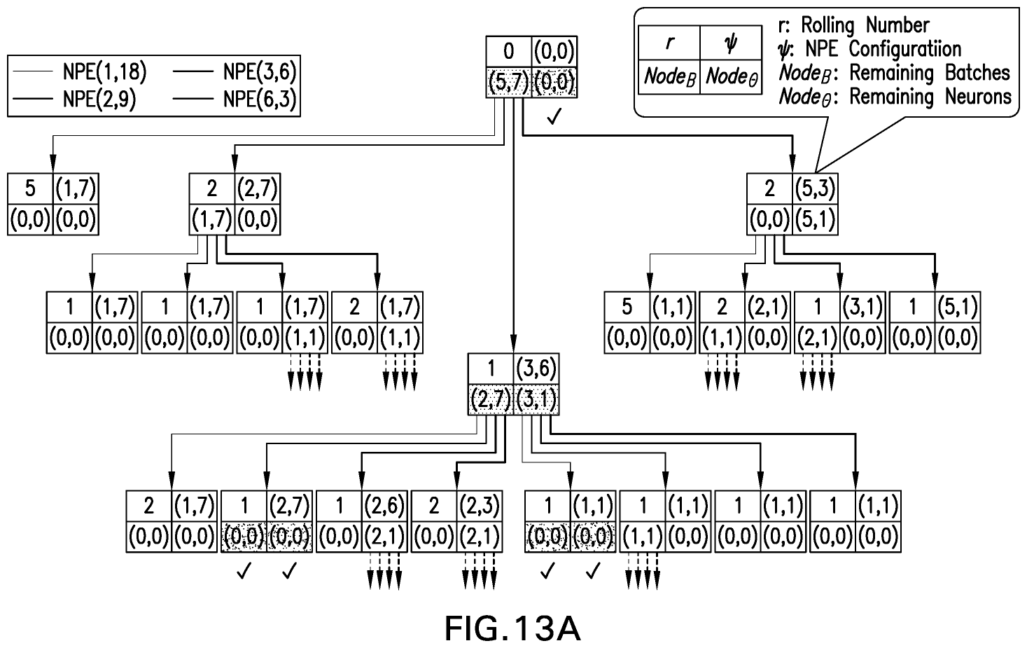

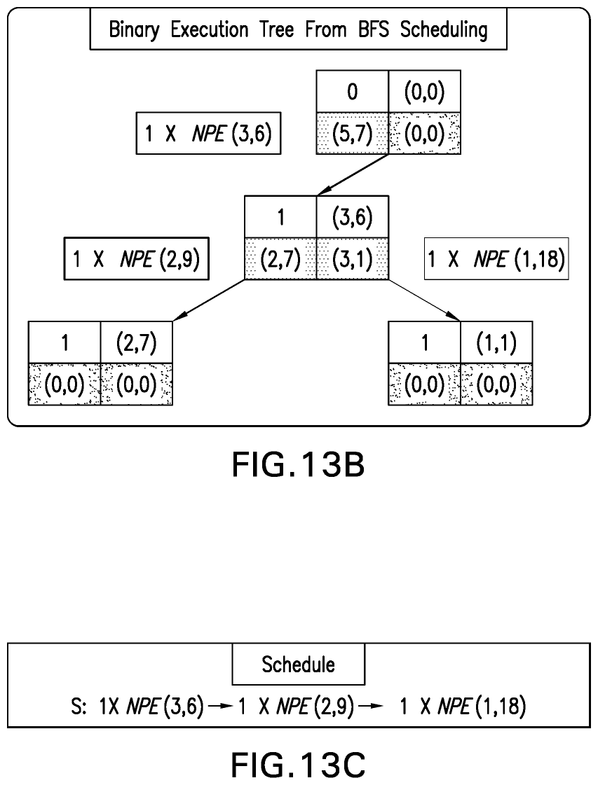

To schedule the sequence of events, the Algorithm 1 first generates the expanded computational tree of the NPE using CreateTree procedure. This procedure first finds all possible ways that NPE could be segmented for processing N neurons of K batches, where K≤B and stores them into configuration database C. Then for each of configurations of NPE(K, N), it derives how many rounds ® of NPE(K, N) computations could be executed. Then it computes a) the number of remaining batches (with no computation) and b) the number of missing neurons in partially computed batches. It, then, creates a tree-node, with four major fields: 1) the load-configuration ψ(Kᵢ*, Nᵢ*) that is used to partially compute the model using the selected NPE(Kᵢ, Nᵢ) such that (Kᵢ*≤Kᵢ) & (Nᵢ*≤Nᵢ), 2) the number of rounds (rolls) r taken with computational configuration w to reach that node, 3) a pointer to a new problem Nodes that specifies the number of remaining batches (with no computation), and 4) a pointer to a new problem Node_{Θ} for partially computed batches. Then the CreateTree procedure is recursively called on each of the Node_{B} and Node_{Θ} until the batches left, and partial computation left in a (leaf) node is zero. At this point, the procedure returns. After computing the computational tree, the mapper extracts the best execution tree by finding a binary tree with the least number of rolls (where all leaf nodes have zero computation left). The number of rolls is computed by summing up the r field of all computational nodes. Finally, the mapper uses a Breath First Search (BFS) on the Execution Tree (Exec_{Tree}) and report the sequence of r×NPE(K, N) for processing the entire binary execution tree. The reported sequence is the optimal execution schedule. FIG. 13A-C provides an example for executing five batches of a hidden MLP layer with seven neurons. As illustrated the computation-tree (FIG. 13A) is first generated, and then the optimal binary execution tree (FIG. 13B) resulting in the minimum number of rolls is extracted. FIG. 13C captures the result of scheduling step where BFS search schedule the sequence of r×NPE(K, N) events.

The Controller is a Finite State Machine (FSM) that receives the “Schedule” from the Mapper and generates the appropriate control signals to control the proper OS data flow for executing the scheduled sequence of events.

The NPE global memory is divided into feature-map memory (FM-Mem), and Filter Weight memory (W-Mem). The FM-Mem consist of two memories with ping-pong style of access, where the input features are read from one memory, and output neurons for the next layer, are written to the other memory. When working with multiple batches (B), the input features from the largest number of fitable batches (B*) is read into feature memory. For simplicity, we have assumed that the feature map is large enough to hold the features (neurons) in the largest layer of at least one MLP (usually the input) layer. Note that the NPE still can be used if this assumption is violated; however, now some of the computed neuron values have to be transferred back and forth between main memory (DRAM) and the FM-Mem for lack of space. The filter memory is a single memory that is filled with the filter weights for the layer of interest. The transfer of data from main memory (DRAM) to the W-Mem and FM-Mem is regulated using Run Length Coding (RLC) compression to reduce data transfer size and energy.

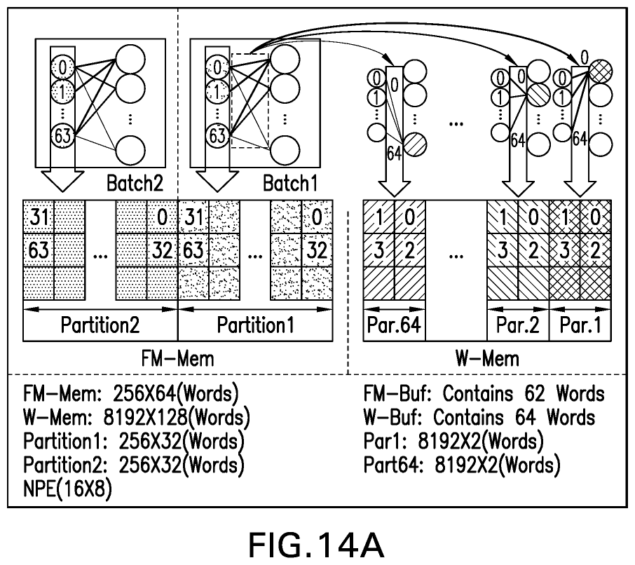

The data arrangement of features and weights inside the FM-Mem and W-Mem is shown in FIG. 14A. The data storage philosophy is to sequentially store the data (weight and input features) needed by NPE (according to its configuration) in consecutive cycles in a single row. This data reshaping solution allows us to reduce the number of memory accesses by reading one row at a time into a buffer, and then consuming the data in the buffer in the next few cycles.

FIG. 14A shows the arrangement of values at the FM-Mem and W-Mem when NPE arrangement is NPE(2, 64) and the input model is F(2, 64). The memory size of FM-Mem and W-Mem are 256×128 (Byte) and 2048×256 (Byte), respectively. Based on this setup, the virtual partition width size for FM-Mem and W-Mem are 64 and 4 Bytes, respectively. So the values of FM, related to Batch1 and Batch2, has been stacked along side each other at the partition1, partition2, respectively, FIG. 14A (left). Following a similar fashion, when W-Mem has been partitioned into 64 parts, with line width 4 Bytes, in which at each part the weights related to each output neuron has been stacked, FIG. 14A right. FIG. 14B shows the first four execution cycles of TCD-NPE at the configuration NPE(2, 64). At the cyclel, one line of FM-Mem containing 64 words, has been fetched. Two words directly broadcast into related Tgs, and the remaining 62 words store into the FM-Buffer for further accesses at the next two cycles. Simultaneously, one line of W-Mem, containing 128 words, has been fetched and 64 words of it directly unicast into TCE-MACs inside of each TG, and the remaining 64 words stores into the W-Buffer for further access at the next cycle. At the second Cycle, two words are read from FM-Buffer and broadcast into related TGs and 64 words are read from W-Buffer for unicasting. At the third cycle, two words are read from FM-Buffer and because W-Buffer is already consumed, another line of W-Mem has been fetched, and similar to cyclel, 64 words of it unicast into TCD-MACs inside of each TG and another 64 words store into the W-Buffer and 64 words read from the M-Buffer. The same scenario occurs for the next cycles of TCD-NPE until all the computations finish. Note, FM-Buffer and W-Buffer reduces the frequency of memory access which in turn, reduces the dynamic power of Memory. For example, at the configuration NPE(2, 64), at each cycle two values of the FM-Buffer and 64 values of W-Buffer are read into TCD-NPE for processing. In this manner FM-Mem access has been reduced to 1/32 and W-Mem access reduced to ½.

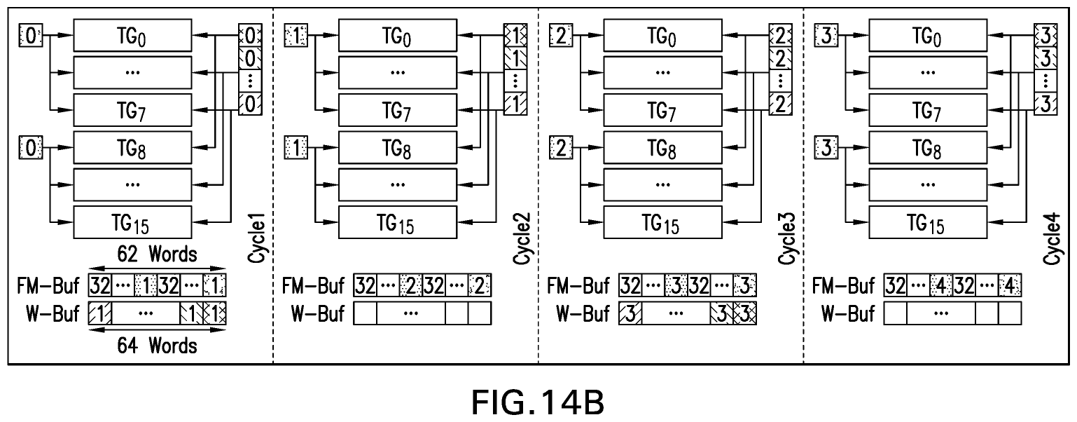

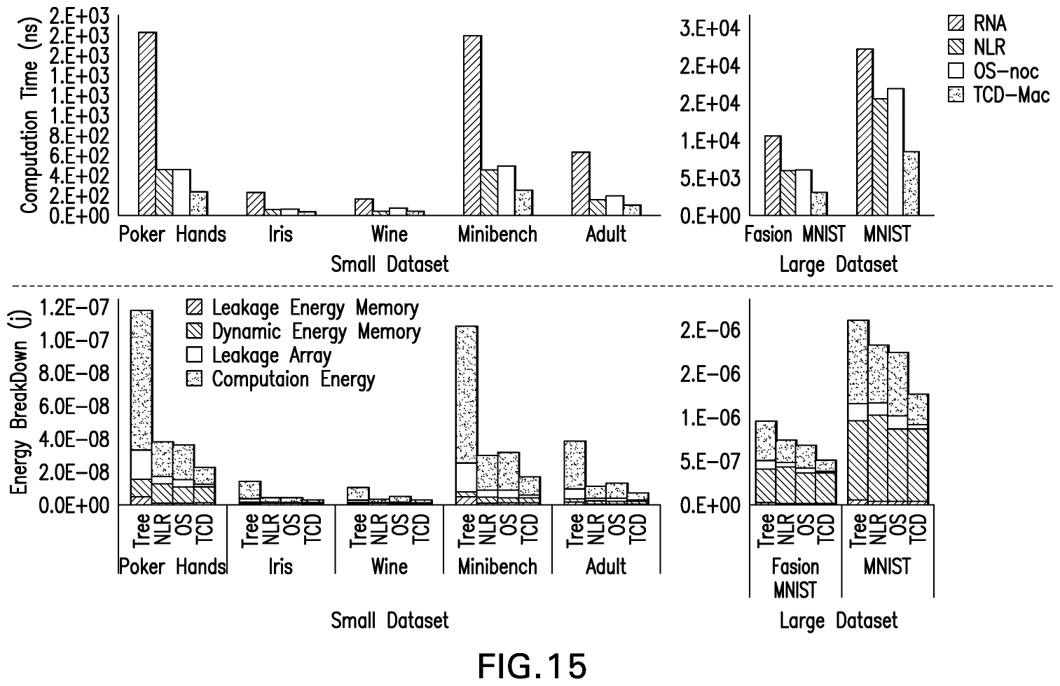

The Local Distribution Networks (LDN) interface the read/write buffers and the Network on Chip (NoC). They manage the desired multi- or uni-casting scenarios required for distributing the filter values and feature values across TGs. FIG. 15 illustrates an example of LDNs in an NPE constructed using 6×3 array of TCD-MACs. As illustrated in this example, the LDNs are used for 1) reading/writing from/to buffers of FM-Mem while supporting the desired multi-/uni-casting configuration (generated by the controller) to support the selected NPE(K, N) configuration (FIG. 14A) and 2) reading from W-Mem Buffer and multi-/uni-casting the result into TGs (FIG. 14B). Note that the LDN in FIG. 14 is specific to PE-array of size 6×3. For other array sizes, a similar LDN should be constructed.

We first evaluate the Power, Performance, and Area (PPA) gain of using TCD-MAC, and then evaluate the impact of using the TCD-MAC in the TCD-NPE. The TCD-MAC and all MACs evaluated operate on signed 16-bit fixed-point inputs.

The PPA metrics are extracted from the post-layout simulation of each design. Each MAC is designed in VHDL, synthesized using Synopsis Design Compiler using 32 nm standard cell libraries, and is subjected to physical design (targeting max frequency) by using the Synopsys reference flow in IC Compiler. The area and delay metrics are reported using Synopsys Primetime. The reported power is the averaged power across 20K cycles of simulation with random input data that is fed to Prime timePX in FSDB format. The general structure of MACs used for comparison is captured in FIGS. 1A and 1B. We have compared our solution to a wide array of MACs. In these MACs, for multiplication, we used Booth-Radix-N (BR×2, BR×4, BR×8) and Wallace implementations. For addition we have used Brent-Kung (BK) and Kogge-Stone (KS) adders (similar adders may also be employed in the practice of the invention). Each MAC is identified by the tuple (Multiplier choice, Adder choice).

TABLE 1
PPA comparison between various MAC flavors and TCD-MAC

| MAC type | Area (μm²) | Power (μw) | Delay (ns) | PDP (pJ) |
|---|---|---|---|---|
| (BR × 2, KS) | 8357 | 467 | 2.85 | 13.31 |
| (BR × 2, BK) | 8122 | 394 | 3.3 | 13 |
| (BR × 8, BK) | 7281 | 383 | 30.14 | 12.03 |
| (BR × 4, BK) | 6437 | 347 | 3.35 | 11.62 |
| (WAL, KS) | 7171 | 346 | 3.04 | 10.52 |
| (WAL, BK) | 6520 | 334 | 3.13 | 10.45 |
| (BR × 4, KS) | 6551 | 393 | 2.47 | 9.71 |
| (BR × 8, KS) | 7342 | 354 | 2.63 | 9.31 |
| TCD-MAC | 5004 | 320 | 1.57 | 5.02 |

Table 1 captures the PPA comparison of the TCD-MAC against a popular set of conventional MAC configurations. As reported, the TCD-MAC has a smaller overall area, power and delay compared to all reported MACs. Using TCD-MAC provides 23% to 40% reduction in area, 7% to 31% improvement in power, and an impressive 46% to 62% improvement in PDP when compared to other reported conventional MACs.

Note that this improvement comes with the limitation that the TCD-MAC takes one extra cycle to generate the correct output when working on a stream of data. However, the power and delay saving of TCD-MAC significantly outweigh the delay and power for one extra computational cycle. To illustrate this, the throughput and energy improvement of using a TCD-MAC for processing a stream of 1000 MAC operations is compared against selected conventional MACs and is reported in Table II. As illustrated, the TCD-MAC can gain 40.3% to 53.1% improvement in throughput, and 46% to 62.2% improvement in energy consumption (albeit taking one extra cycle) when processing the steam of MAC operations.

TABLE II
Percentage improvement in Throughput and Energy when
using a TCD-MAC compared to a conventional MAC to
process 1K multiplication and addition operations.

| | Throughput Improvement (%) | | | | Energy Improvement (%) | | | |
|---|---|---|---|---|---|---|---|---|
| MAC Type | 1 | 10 | 100 | 1K | 1 | 10 | 100 | 1K |
| BR × 2, KS | 25 | 59 | 62 | 63 | −10 | 40 | 45 | 45 |
| BR × 2, BK | 23 | 58 | 62 | 62 | 5 | 48 | 52 | 53 |
| BR × 8, BK | 17 | 55 | 58 | 59 | 0 | 45 | 50 | 50 |
| BR × 4, BK | 14 | 53 | 57 | 57 | 7 | 49 | 53 | 54 |
| WAL, KS | 5 | 48 | 52 | 53 | −3 | 44 | 48 | 49 |
| WAL, BK | 4 | 48 | 52 | 52 | 0 | 45 | 50 | 50 |
| BR × 4, KS | −3 | 44 | 48 | 49 | −27 | 31 | 36 | 37 |
| BR × 8, KS | −7 | 41 | 46 | 47 | −19 | 35 | 40 | 41 |

We describe the result of our TCD-NPE implementation as described above. Table III summarizes the characteristics of TCD-NPE implemented, the result of which is reported and discussed in this section. For physical implementation, we have divided the TCD-NPE into two voltage domains, one for memories, and one for the PE array. This allows us to scale down the voltage of memories as they had considerably shorter cycle time compared to that of PE elements. This choice also reduced the energy consumption of memories and highlighted the saving resulted from the choice of MAC in the PE-array.

TABLE III
TCD-NPE implementation details.

| Feature | Detail | Feature | Detail |
|---|---|---|---|
| PE-array | 16 × 8 (128 TCD-MACs) | Processing | TCD-MAC |
| | | Element | |
| Data Input | Signed 16-bit fixed point | FM-Mem size | 2 × 64K |
| | | | Byte |
| W-Mem size | 128K Byte | Activation Units | Relu |
| Mapper | Off-chip using Alg. 1 | PE-array voltage | 0.95 V |
| Data Flow | OS | Mem voltage | 0.72 V |

Table IV captures the overall PPA of the implemented TCD-NPE extracted from our post layout simulation results which are reported for a Typical Process, at 85° C. temperature, when the voltage of the PE-array and memory elements are set according to Table III. Note that dynamic power is dependent on activity. For reporting dynamic power, we have assumed 100% PE-array utilization.

TABLE IV
TCD-NPE implementation PPA results.

| Feature | Value | | Feature | Value | |
|---|---|---|---|---|---|
| Area | 3.54 | mm² | Max Frequency | 636 | MHZ |
| PE-array Area | 0.724 | mm² | Memory Area | 2.5 | mm² |
| Overall Leakage Power | 166 | mW | Memory Leakage Power | 120 | mW |
| PE-array Leakage Power | 30 | mW | Others Leakage Power | 16 | mW |
| Overall Dynamic Power | 800 | mW | Memory Dynamic Power | 450 | mW |
| PE-array Dynamic Power | 310 | mW | Others Dynamic Power | 30 | mW |

To compare the effectiveness of TCD-NPE, we compared its performance with a similar NPE which is composed of conventional MACs. We limit our evaluation to the processing of MLP models. Hence, the only viable data flows are OS and NLR. The TCD-MAC only supports OS; however, by replacing a TCD-MAC with a conventional MAC, we can also compare our solution against OS and NLR. We compare four possible data flows that are illustrated in FIG. 11. In this Figure, case (A) is NLR data flow (supported only by conventional MAC) for computing the Neuron values by forming a systolic array withing the PE-array. The case (B) is an NLR data flow variant when the computation tree is unrolled and mapped to the PEs, forcing the PE to either act as an adder or multiplier. The case (C) is the OS data flow realized by using conventional MAC. And, finally, the case (D) is the OS data flow implemented using TCD-NPE.

For OS dataflows, we have used the Algorithm 1 to schedule the sequence of computational rounds. We have compared the efficiency of each of four data flows (described in FIG. 11) on a selection of popular MLP benchmarks characteristic of which is described in Table V.

TABLE V
MLP benchmarks used.

| Applications | Dataset | Topology |
|---|---|---|
| Digit Recognition | MNIST | 784:700:10 |
| Census Data Analysis | Adult | 14:48:2 |
| FFT | Mibench data | 8:140:2 |
| Data Analysis | Wine | 13:10:3 |
| Object Classification | Iris | 4:10:5:3 |
| Classification | Poker Hands | 10:85:50:10 |
| Classification | Fashion MNIST | 728:256:128:100:10 |

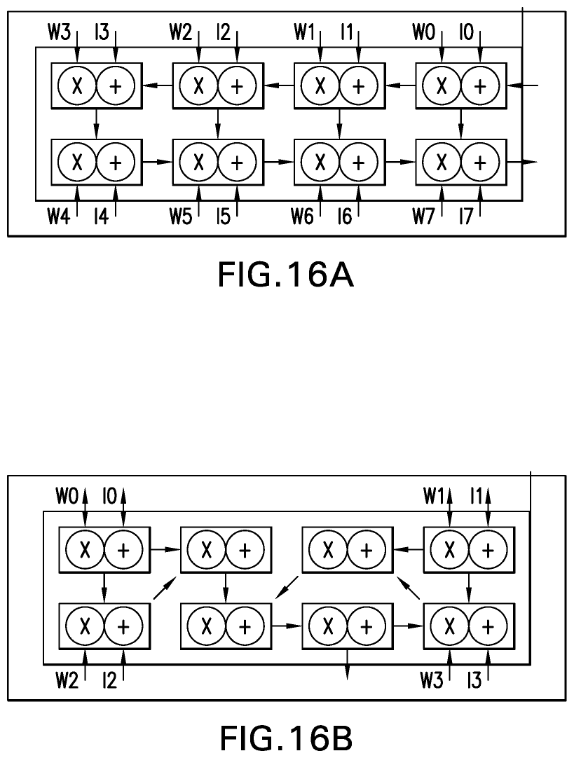

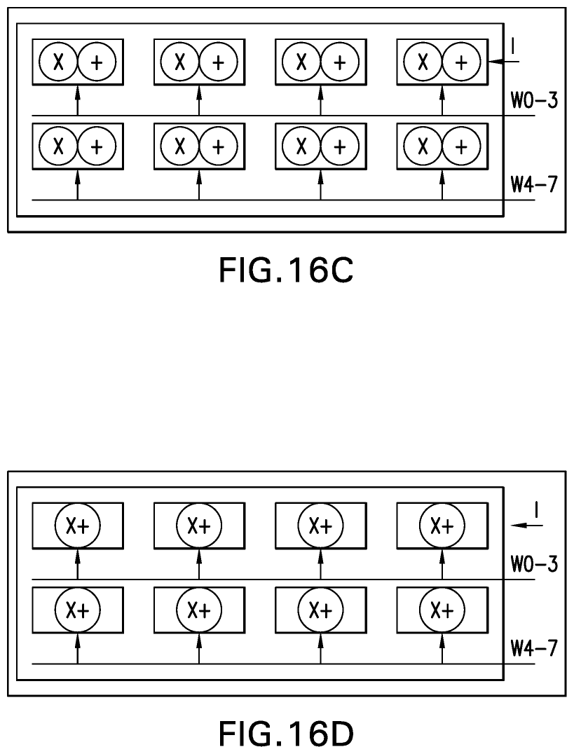

As illustrated in FIG. 16 , on the left, the execution time of the TCD-NPE is almost half of an NPE that uses a conventional MAC in either OS or NLR data flow, and significantly smaller than the RNA data flow (an NLR variant)}. FIG. 16 on the right captures the energy consumption of the TCD-NPE and compares that with a similar NPE constructed using conventional MACs. For each benchmark, the energy consumption is broken into 1) computation energy of PE-array, 2) the leakage of the PE-array, 3) the leakage of the memory, and 4) the dynamic energy of memory (and buffer combined). Note that the voltage of the memory is scaled to a lower voltage, as described in Table V. This choice was made as the cycle time of the PEs was significantly shorter than the memory cycle times. The scaling of the memory voltage increased its associated cycle time to one cycle, however, significantly reduced its dynamic and leakage power, making the PE-array energy consumption the largest energy consumer. In addition, note that by sequentially shaping the data in the memories, and usage of buffers, we significantly reduced the number of required memory accesses, resulting in a significant reduction in the dynamic power consumption of the memories. As illustrated, the TCD-NPE not only produces the fastest solution but also produces the least energy-consuming solutions across all NPE configurations, all data flows and all simulated benchmarks.

We introduced TCD-MAC, a novel processing engine for efficient processing of MLP Neural Networks. The TCD-MAC benefits from its ability to generate temporal carry bits that could be passed to be included in the next round of computation without affecting the overall results. When comparing the MAC operation across multiple channels, the TCD-MAC generates an approximate sum and a temporal carry in each cycle. In the last cycle, when processing the last MAC operation, TCD-MAC takes an additional cycle, free run, and adds the remaining carries to the approximate sum to generate the correct output.

We also introduced NESTA, a specialized Neural engine that significantly accelerates the computation of convolution layers in a deep convolutional neural network, while reducing the computational energy. Rather than computing the precise result of a convolution per channel, NESTA quickly computes an approximation of its partial sum, and a residual value such that if added to the approximate partial sum, generates the accurate output. Then, instead of immediately adding the residual, it uses (consumes) the residual when processing the next batch in the hamming weight compressors with available capacity. This mechanism shortens the critical path by avoiding the need to propagate carry signals during each round of computation and speeds up the convolution of each channel. In the last stage of computation, NESTA terminates by adding the residual bits to the approximate output to generate a correct result.

1. A Temporal-Carry-Differing Multiply-Accumulate (TCD-MAC) logic unit comprising:
a Data Reshaping Unit (DRU) which receives pairs of multiplicands and multipliers, converts each multiplication to a sequence of additions by ANDing each bit value of the multiplier with the multiplicand and shifting the resulting binary and returns a bit-aligned version of the resulted partial products;
a Sign Expansion Unit (SEU) which produces sign bits;
a Generation Unit (GEN) which specifies boundaries between Units of the TCD-MAC that lie inside a skip block and Units of the TCD-MAC that like outside the skip block;
multiple Compression and Expansion Layers (CEL) which receives bit-aligned partial sums at the output of the DRU, the temporary sum generated by the GEN unit, and a Propagate (carry) value generated by the GEN unit;
a Carry Propogation Adder Unit (CPAU);
a Carry Buffer Unit(CBU) in a form of a set of registers that store propagate/carry bits generated by the GEN unit at each cycle and provide this value to CEL layers of the CEL in the next cycle; and
an Output Register Unit(ORU) which captures the output of the GEN unit in the first n−1 cycles or PCPA in the last cycle of operation.

2. The TCD-MAC of claim 1, wherein the input to the DRU is variable.

3. The TCD-MAC of claim 1, wherein the CEL and CPAU are configured for adjustable approximation.

4. The TCD-MAC of claim 1, wherein carry bits are pushed temporally, rather than spatially, to be included in a next round of computation.

5. The TCD-MAC of claim 1, further comprising hamming weight compressors (HWC), wherein the HWC and CPAU perform the functions of a multiplier and accumulator, the HWC facilitating the ability to consume temporal carries and providing carry return from any level to reduce path delay.

6. The TCD-MAC of claim 1 wherein the CPAU is a Kogge Stone adder.

7. The TCD-MAC of claim 1 wherein the GEN defines a boundary between two modes of operation of the TDC-MAC which are Carry Differing Mode (CDM) and Carry Propagation Mode (CPM).

8. A specialized Neural engine (NESTA) that accelerates computation of convolution layers in a deep convolutional neural network while reducing the computational energy, comprising:
a reformatter which reformats convolutions into variable sized batches; and
a hierarchy of Hamming Weight Compressors (HWCs) which receives the batches from the reformatter and processes each batch, when processing the convolution across multiple channels, the HWCs, rather than computing a precise result of a convolution per channel, quickly computes an approximation of its partial sum and a residual value such that if added to the approximate partial sum, generates an accurate output;
whereby, instead of immediately adding the residual value, the HWCs use the residual value when processing a next batch in the HWCs with available capacity to shorten a critical path by avoiding the need to propagate carry signals during each round of computation and speeds up the convolution of each channel, and
in a last stage of computation, when a partial sum of the last channel is computed, Neural engine terminates by adding the residual value to an approximate output to generate a correct result.

9. The specialized Neural engine of claim 8, wherein a sequence of Hamming Weight Compressions followed by a single add operation are used to perform Multiply and Accumulate (MAC) operations, whereby in the last cycle, when working on the last batch of inputs, the Neural engine computes the correct output by using a Partial Carry Propagation Adder (PCPA) to consume remaining carry bits and by performing the complete addition, the add operation generating a correct partial sum whenever executed but, to avoid a delay of the add operation, the add operation is postponed until the last cycle.

10. A Neural Processing Engine (NPE), NESTA, comprising:
a Processing Element (PE) array which is a tiled array of Temporal-Carry-Differing Multiply-Accumulate (TCD-MAC) logic units, each TCD-MAC logic unit operable in two modes selected from the group consisting of Carry Deferring Mode (CDM), and Carry Propagation Mode (CPM);
a Local Distribution Network (LDN) that manages the PE-array connectivity to memories;
two global buffers, wherein a first global buffer of said two global buffers for storing the filter weights and a second global buffer of said two global buffers for storing feature maps; and
a mapper-and-controller unit which translates a Multi-Layer Perceptrons (MLPs) model into a supported data and control flow, wherein the controller of the mapper-and-controller receiving a schedule from the mapper of the mapper-and-controller, and generating appropriate control signals to control proper data flow for executing a scheduled sequence of events.

11. The NPE of claim 10 wherein when working with an input stream of size N, the TCD-MAC is operated in the CDM model for N cycles computing approximate sums, and in the CPM mode in the last cycle to generate the correct output and insert it on a Network on Chip (NoC) bus for writing to memory.

12. The NPE of claim 11 wherein size N corresponds to when there are N neurons in a previous layer of MLP, and a TCD-MAC is used to compute a Neuron value in a next layer.
